(19) United States
(12) Patent Application Publication
(10) Pub. No.: US 2026/0184254 A1
(43) Pub. Date: Jul. 2, 2026

(54) EXTENDABLE CAMPER

(71) Applicant: Outlier Campers LLC, Cambridge, MA (US)

(72) Inventors: Ananda Wickramasekera, Cambridge, MA (US); Paul Deutschman, Montreal (CA)

(21) Appl. No.: 19/173,378

(22) Filed: Apr. 8, 2025

Related U.S. Application Data
(60) Provisional application No. 63/740,106, filed on Dec. 30, 2024.

(51) Int. Cl. B60P 3/34

(52) U.S. Cl. CPC B60P 3/34

(57) ABSTRACT

An extendable camper includes a main body and at least one external extension body capable of moving between retracted and extended positions. In the extended position, the external extension body forms additional living space, while in the retracted position, it collapses for compact travel. Some versions feature two opposing extension bodies that pivot outward, with at least one section made of a soft shell. Other variations include angled or sloped walls, rails or hinges for sliding, and collapsible shelters mounted on top. By forming independent enclosures when extended, the camper effectively increases accommodation. Features such as curtain vestibules, awnings, and pivoting floors or walls further optimize space usage. This flexible approach to extension, combined with lightweight materials and a modular design, enhances practicality and versatility for outdoor enthusiasts.

### CROSS-REFERENCE TO RELATED APPLICATIONS

This application claims under 35 U.S.C. § 119(e) the benefit of U.S. Provisional Patent Application No. 63/740,106 filed Dec. 30, 2024, and titled “EXTENDABLE CAMPER,” the disclosure of which is hereby incorporated herein by reference in its entirety.

### TECHNICAL FIELD

The present disclosure generally relates to recreational vehicles and, more particularly, to extendable campers that include one or more external extension bodies movable between retracted and extended positions. Such campers provide a compact form for travel or storage can be expanded at a campsite or other destination to create additional living or storage space, thereby enhancing convenience and usability.

### BACKGROUND

An existing camper may include an extension body that extends away from the main camper body; however, various existing designs may exhibit different forms of dependence between these bodies. For instance, the extension body may be internal to the main body when retracted and partially slide out when extended, yet both bodies depend on each other to form a complete enclosure, whether retracted or extended (e.g., a camper slide-out). Alternatively, the extension body may be external to the main body, but the two bodies may not form independent enclosures (i.e., they are not sealed independently of each other and only together form a complete enclosure, whether retracted or extended). Another possibility is that the extension body may be external to the main body, while the main body depends on the extension body for a complete camper (e.g., the extension body contains certain essential components such as the camper's wheels, chassis, and/or other necessary features, and the main body contains other necessary elements, such as the interior or living space, so that both bodies together form a complete camper).

An existing camper may also include a fixed, non-extending external body (e.g., a “tongue box” on a trailer or a storage box attached to a side of the main body) that is independently sealed from the main camper body. However, because this external body does not move away from the main body, it continues to block a side or a portion of a side of the main body to which it is attached or nearby. An existing camper may also include either an awning or an external tent vestibule, but the awning may not be hard-sided or contain a compartment, and the tent vestibule may not be hard-sided or be retractable to or extendable away from the main body. Additionally, an existing camper may feature elements such as an external kitchen or compartment (e.g., located outside the main living area and accessible from outside, such as a teardrop camper rear galley kitchen or a trailer tongue box located in the front). Because access to these areas is from the camper's outer-facing sides—which may require specific shapes or other features for better aerodynamics or performance while in transit—openings can be small or features may be inconvenient to reach (e.g., a rear galley kitchen in a teardrop trailer may have fixtures that are uncomfortably high or an opening that is small due to the rear of the trailer needing to be angled upward for a better departure angle or shaped for improved aerodynamics; or a tongue box or storage compartment in the front of a trailer may have a narrow opening because it needs to be pointed for aerodynamic reasons or accommodate the narrowing trailer tongue toward the hitch coupler).

It may therefore be beneficial for a camper to have a main body (e.g., a hard-sided camper body) and an extension body (e.g., a hard-sided extension body) that can move between a retracted position, where it is adjacent to the main body, and an extended position, where it is extended or pivoted away from the main body. The main body and the extension body may each form an independent enclosure, and the main body need not depend on the extension body to constitute a self-contained camper (e.g., it may be fully sealed and contain at least basic components such as an interior space and wheels and a chassis if not mounted on another structure, as well as trailer components if it is towable). The extension body may contain one or more compartments, enclosures, and/or other features and components, and, in the extended position, all or part of most sides of the main body (e.g., the front, rear, left, right, and top sides) and/or the extension body—where these sides are adjacent in the retracted position—may become accessible, allowing openings, enclosures, compartments, fixtures, features, and/or other components to be used, accessed, extended, or opened. Openings to enclosures or features on the inward-facing surfaces (i.e., surfaces that face or are adjacent to those of the main body) of the extension body can be larger or more conveniently accessible, while the outward-facing surfaces of the extension body may have any beneficial shape and/or features for better aerodynamics, performance, or compliance with vehicle regulations during transit. When extended, the sides of the extension body together with the sides of the main body may form an additional full or partial enclosure, while, in the retracted position, the extendable camper may occupy a smaller footprint for transportation or storage.

The extendable camper described herein may have a main body (e.g., a hard-sided body) that is self-contained and may include a frame, an interior living space, lights, wheels and a chassis if not mounted on another structure such as a pickup bed or truck chassis, and a trailer tongue with a hitch coupler, jack, and/or other trailer components if towable. The main body may be configured so that an extension body (e.g., a hard-sided body) is attached to or near at least one of its external sides. The extension body may be configured to move between a retracted position, where one or more of its sides is adjacent to one or more sides of the main body, respectively, and an extended position, where it is extended or pivoted away from the main body so that one or more of its sides is not, or not fully, adjacent to the sides of the main body. The extension body may be extendable by one or more slides (e.g., heavy-duty slides similar to drawer slides) with a fixed portion of each slide attached to the main body and a slidable portion of each slide attached to the extension body (or vice versa), allowing the extension body to slide horizontally toward or away from the main body. Alternatively or additionally, the extension body may pivot by one or more hinges, where one part of the hinge is attached to the main body and another part is attached to the extension body, allowing the extension body to pivot toward or away from the main body.

The extension body may include one or more compartments for storage, kitchen and/or bath components, utility components, and/or a vestibule room (e.g., for changing clothes or as a shelter from inclement weather and/or insects). The main body and the extension body may each be independently sealed, forming separate enclosures. This arrangement may reduce or eliminate the need for complex or cumbersome sealing between the main body and the extension body that must work in both retracted and extended positions.

When the camper is in the retracted position, one or more sides of the main body lie adjacent to one or more sides of the extension body, which may block access to those sides on both bodies. However, when the extension body is extended or pivoted away, those sides of both bodies become accessible. The main body and extension body may have five pairs of respective adjacent sides (e.g., at or near the front, rear, left, right, and top sides of the main body), four pairs, three pairs, two pairs, one pair, or one side of the main body may be adjacent to more than one side of the extension body. Alternatively, the camper may have multiple extension bodies, each extendable individually (e.g., one located at or near the front side and another at or near the rear side of the main body, or two or more extensions located at or near two or more other sides of the main body). In the retracted position, adjacent to the main body, the camper may have a smaller footprint (e.g., reduced length and/or width), which can be advantageous for transportation or storage. In the extended or pivoted-away position, side features on the extension body and the main body that are adjacent and inaccessible when retracted can become available. These side features may include openings such as doors, fixed or openable windows, hatches, ports, vents, or other openings; fixed or extendable compartments or enclosures for storage, utilities, kitchen fixtures, bath fixtures, and/or other living fixtures (e.g., beds, seating, tables); external fixtures such as storage racks, brackets, hooks, supports, fold-out tables or chairs, cots or hammocks, solar panels, hoses, HVAC connections, plumbing connections, electrical connections, and/or other utilities; or other components or fixtures. The inward-facing surfaces of the extension body (those surfaces that lie adjacent to the main body when retracted) may have larger surface areas and/or contain larger openings or more convenient access to fixtures or features on those surfaces when extended, while the outward-facing surfaces of the same sides may incorporate shapes or other features that offer aerodynamic or performance benefits during transit. In addition, when the camper is extended, sides of the extension body together with sides of the main body may form an additional full or partial enclosure.

### SUMMARY OF THE DISCLOSURE

Described herein is an extendable camper that includes a main body (e.g., a hard-sided camper body) and an extension body (e.g., a hard-sided extension body) configured to move between a retracted position, where the extension body is adjacent to the main body, and an extended position, where the extension body is extended or pivoted away from the main body. The main body and the extension body may each form an independent enclosure in both retracted and extended positions, and the main body is not dependent on the extension body to form a self-contained camper (e.g., the main body can function as a camper with or without the extension body). Openings, compartments, storage cabinets, fixtures, features, or other components located in or on the sides of both the main and extension bodies that are adjacent to each other in a retracted position (and may be blocked in that position) may be more accessible in an extended position. Inward-facing surfaces of the extension body can provide greater surface area and easier accessibility for openings, enclosures, or features, while outward-facing surfaces of the extension body may incorporate shapes or features that offer better aerodynamics or improved performance when the camper is in transit. When the extension body is extended, its sides, in conjunction with sides of the main body, may form additional full or partial enclosures.

The extendable camper described herein may also include a main body (e.g., a hard-sided camper body) and an extension body (e.g., a hard-sided extension body) configured to move between a retracted position, where the extension body is adjacent to the main body, and an extended position, where the extension body is extended or pivoted away from the main body. The main body and the extension body may each form an independent enclosure in both retracted and extended positions (e.g., each is independently sealed). The main body is not dependent on the extension body to form a self-contained camper (e.g., the main body can function as a camper with or without the extension body). Side features (e.g., features in the side walls or roof)—such as openings, compartments, storage cabinets, kitchen fixtures, bathroom fixtures, utility fixtures, or other components—that are located on or in sides of both the main and extension bodies, and that are adjacent to each other in a retracted position (and may be blocked or inaccessible then), can become more accessible in an extended position. Inward-facing surfaces of the extension body offer increased surface area and easier access to openings, enclosures, or features, while outward-facing surfaces of the extension body may contain shapes or features that improve aerodynamics or performance while the camper is in transit. When the extension body is extended, sides of the extension body together with sides of the main body may form additional full or partial enclosures.

The extendable camper may include a main body (e.g., a hard-sided body) that is self-contained, potentially incorporating a frame; an interior living space; lights; wheels and a chassis if it is not mounted on another structure such as a pickup bed or truck chassis; a trailer tongue with a hitch coupler, jack, or other trailer components if it is towable; a motor, drivetrain, and other vehicle components if motorized (e.g., a recreational vehicle or R.V.); and other necessary components. The main body may be fully sealed (e.g., against water and insects), forming an independent enclosure that does not rely on the extension body. It may include, in or on its sides (e.g., front, rear, left, right, or top sides), openings such as doors, windows (fixed or openable), hatches, ports, vents, and other apertures; fixed or extendable compartments or enclosures for storage, utilities, kitchen fixtures, bath fixtures, or living fixtures (e.g., beds, seating, tables); external fixtures such as racks, brackets, hooks, supports, fold-out tables, chairs, cots, hammocks, solar panels, hoses, HVAC connections, plumbing connections, electrical connections, or other utilities; and other components or fixtures. The main body may also include portions of a sliding mechanism, such as the fixed portion of one or more heavy-duty slides, or portions of a hinge.

The main body may be configured so that an extension body (e.g., a hard-sided body) can attach to or be placed adjacent to at least one of its external sides. One or more slides and/or hinges—portions of which may be attached to the main body—allow the extension body, which may include a corresponding sliding portion or hinge portion, respectively, to extend or pivot away from the main body. The extension body can thus move between a retracted position, where one or more of its sides is adjacent to one or more sides of the main body, and an extended position, where it is extended or pivoted away, so that those sides are no longer, or not fully, adjacent. The extension body may slide horizontally toward or away from the main body via the one or more slides, and/or pivot toward or away from the main body via the one or more hinges. The extension body may be fully sealed (e.g., against water or insects), forming an independent enclosure that is not dependent on the main body, aside from its attachment via slides or hinges. The extension body may include openings (doors, windows, hatches, ports, vents, and other apertures), compartments or enclosures (storage, utilities, kitchen, bath, or other living fixtures), or external fixtures (racks, brackets, hooks, supports, solar panels, hoses, HVAC connections, plumbing or electrical connections, etc.).

When the camper is in a retracted position, one or more sides of the main body can be adjacent to one or more sides of the extension body, blocking access to the adjacent sides or features. When the extension body is extended or pivoted away, those adjacent sides and features become accessible. In the extended position, features on the adjacent sides of the main body and/or extension body (including doors, windows, hatches, compartments for storage, utilities, or living fixtures, or external fixtures like racks, brackets, fold-out tables, solar panels, or utility connections) can be used, opened, exposed, extended, connected, or accessed.

The main body and extension body may have five pairs of adjacent sides (e.g., located at or near the front, rear, left, right, and top sides of the main body); four pairs of adjacent sides (e.g., four out of those five sides); three pairs; two pairs; one pair; or one or more sets of adjacent sides where one side of the main body is adjacent to more than one side of the extension body. The extendable camper may also include multiple extension bodies, each individually extendable or pivotable (e.g., two or more extension bodies located at or near multiple sides of the main body). Portions of the main body's frame, such as the tongue in a trailer application, or frame extensions at the rear or sides, can also be adjacent to portions of the extension body. When extended or pivoted away, features on each pair of adjacent sides of the main body and extension body (or on portions of the main body's frame that extend beyond the body and are adjacent to the extension body in a retracted position) may become accessible. In the retracted position, with the extension body against the main body, the camper can occupy a smaller footprint (e.g., reduced length or width), which is preferable or necessary for transportation and storage. The side of the extension body that abuts or faces the main body in a retracted position may have larger or lower openings, or otherwise offer easier access to features on that surface (when extended), while the outward-facing surfaces may have shapes or features beneficial for travel, such as an angled front side for improved aerodynamics, an angled rear for a better departure angle, or flat, ruggedized, or otherwise optimized left, right, and top sides for performance on or off road.

When the extension body is extended or pivoted away from the main body, one or more sides of the extension body—alone or together with one or more other sides of the extension body, or one or more sides of the main body—may form additional full or partial enclosures of the extendable camper. For example, if the extension body has more than one side adjacent to multiple sides of the main body when retracted, in the extended position each side of the extension body might form an enclosure with the same or different side(s) of the main body. If there are multiple extension bodies, they may also form one or more full or partial enclosures with each other and/or with the main body when extended. These additional enclosures can shelter features on the sides of the main body and/or extension bodies, making them more fully or partially protected and accessible from within.

The extension, pivoting, or retraction of the camper can be done manually, via powered mechanisms, or a combination of both. One or more extension bodies extendably connected to the main body may be moved by powered actuators or motors, manually assisted means such as gas springs, struts, or other spring mechanisms, or purely manual efforts (pulling, pushing, pivoting). Where slides are used, they may include locks, latches, or similar mechanisms that secure the extension body at specific positions (e.g., retracted or extended) until unlocked or unlatched. Where hinges are used, the hinges or pivoting mechanism may likewise contain locks, latches, or similar features to hold the extension body securely at chosen positions (e.g., retracted or pivoted) until released.

In some embodiments, an extendable camper comprises a main body and a first external extension body and a second external extension body configured to move between a retracted position, in which the main body is collapsed into the second external extension body and the second external extension body is collapsed into the first external extension body, and an extended position, in which the external extension bodies extend or pivot outward horizontally in opposite directions from the main body. The external extension bodies and sides of the main body may form enclosures, respectively, in the extended position. At least a part of the second external extension body may be made of a soft shell. A front wall of the first external extension body may be angled. A rear wall of the first external extension body may be connected to a floor of the first external extension body via an upwardly sloping wall. The external extension bodies may slide by rails or pivot by hinges between the retracted position and the extended position, respectively. The floors of the first and second external extension bodies may be pivoted from side walls of the main body by hinges, respectively. The extendable camper may further comprise a collapsible shelter. The collapsible shelter may be positioned on a top side of the main body.

In some embodiments, an extendable camper includes a main body and a first external extension body and a second external extension body configured to move between a retracted position—where the main body is collapsed into the first external extension body and the second external extension body is collapsed into the main body—and an extended position—where the external extension bodies extend or pivot outward in opposite directions from the main body, and the main body forms an independent enclosure. The external extension bodies and sides of the main body may form enclosures, respectively, in the extended position. At least a part of the second external extension body may be made of a soft shell. A front wall of the first external extension body may be angled. A rear wall of the first external extension body may be connected to a floor of the first external extension body via an upwardly sloping wall. The external extension bodies may slide by rails or pivot by hinges between the retracted position and the extended position. At least one of the floors of the first and second external extension bodies may be pivoted or hinged from side walls of the main body. An extendable camper may further comprise a collapsible shelter. The collapsible shelter may be positioned on a top side of the main body.

In some embodiments, an extendable camper includes a main body and an external extension body configured to move between a retracted position—where the external extension body is positioned adjacent to the main body—and an extended position—where the external extension body and a side of the main body form a partial enclosure. The external extension body may slide by a rail or pivot by a hinge between the retracted position and the extended position. A front wall of the external extension body may be angled. A collapsible shelter may be included. The collapsible shelter may be positioned on a top side of the main body.

In some embodiments, an extendable camper includes a main body and an external extension body configured to move between a retracted position—where the external extension body is positioned adjacent to the main body—and an extended position—where the external extension body extends or pivots outward horizontally from the main body such that the main body and the external extension body each form independent enclosures. In the extended position, the external extension body may form a front-end body of the extendable camper. The external extension body may slide by a rail or pivot by a hinge between the retracted position and the extended position. The external extension body may include curtain vestibules, and an awning extended out from the main body. A collapsible shelter may be included. The collapsible shelter may be positioned on a top side of the main body.

### BRIEF DESCRIPTION OF DRAWINGS

FIG. 1 is a front perspective view of an exemplary extendable camper with two extension bodies extended away from five sides of a main body, according to some embodiments of the present disclosure.

FIG. 2 is a left, rear perspective view of the exemplary extendable camper of FIG. 1.

FIG. 3 is a right, front perspective view of the exemplary extendable camper of FIG. 1 in a retracted position.

FIG. 4 is a left, rear perspective view of the exemplary extendable camper of FIG. 3.

FIG. 5 is a right, front perspective view of a main body of the exemplary extendable camper of FIG. 1.

FIG. 6 is a left perspective view of a first extension body of the exemplary extendable camper of FIG. 1.

FIG. 7 is a view of a floor side of an extension body of the exemplary extendable camper of FIG. 1.

FIG. 8 is a left perspective view of the extension body of FIG. 6, showing sliding portions extended away from fixed portions of exemplary slides.

FIG. 9 is a left, rear perspective view of the exemplary extendable camper of FIG. 1, with a first extension body extended away from the main body and a second extension body retracted to the main body.

FIG. 10 is a right, rear perspective view of the exemplary extendable camper of FIG. 9, showing a floor side of the first extension body in the process of pivoting away from or toward the main body.

FIG. 11 is a right, rear perspective view of the exemplary extendable camper of FIG. 9, showing the second extension body extended and a soft-sided wall attached.

FIG. 12 is a right, front perspective view of another exemplary extendable camper, with an extension body having three sides retracted to three sides of a main body, according to some embodiments of the present disclosure.

FIG. 13 is a left, rear perspective view of the exemplary extendable camper of FIG. 12.

FIG. 14 is a left, rear perspective view of the exemplary extendable camper of FIG. 12 in an extended position.

FIG. 15 is a right perspective view of the exemplary extendable camper of FIG. 14.

FIG. 16 is a left, front perspective view of the exemplary extendable camper of FIG. 14, showing openings in the main body in open positions.

FIG. 17 is a right, front perspective view of the exemplary extendable camper of FIG. 14, showing openings in both the main body and the extension body in open positions.

FIG. 18 is a right, rear perspective view of the exemplary extendable camper of FIG. 17.

FIG. 19 is a right, front perspective view of another exemplary extendable camper, with an extension body having one side retracted to one side of a main body, according to some embodiments of the present disclosure.

FIG. 20 is a left, front perspective view of the exemplary extendable camper of FIG. 19 in an extended position.

FIG. 21 is a right, rear perspective view of the exemplary extendable camper of FIG. 20.

FIG. 22 is a left, rear perspective view of another exemplary extendable camper, with an extension body having one side retracted to a top side of a main body, according to some embodiments of the present disclosure.

FIG. 23 is a view of the exemplary extendable camper of FIG. 22 in an extended position.

FIG. 24 is a right, front, bottom perspective view of the exemplary extendable camper of FIG. 22, with a soft-sided compartment in a stored position.

FIG. 25 is a left, rear perspective view of the exemplary extendable camper of FIG. 24, with its soft-sided compartment in an expanded position.

FIG. 26 is a left, rear perspective view of another exemplary extendable camper, featuring an extension body with powered movement and one side retracted to a top side of a main body, according to some embodiments of the present disclosure.

FIG. 27 is a view of the exemplary extendable camper of FIG. 26 in an extended position.

FIG. 28 is a right, front, bottom perspective view of the exemplary extendable camper of FIG. 27.

FIG. 29 is a left, front perspective view of another exemplary extendable camper, with an extension body having two sides retracted to two sides of a main body, according to some embodiments of the present disclosure.

FIG. 30 is a view of the exemplary extendable camper of FIG. 29 in an extended position.

FIG. 31 is a right, rear perspective view of the exemplary extendable camper of FIG. 30.

FIG. 32 is a left, front perspective view of the exemplary extendable camper of FIG. 31, with a soft-sided compartment expanded.

FIG. 33 is a right perspective view of another exemplary extendable camper, with an extension body having one side retracted to one side of a main body and a collapsible shelter fixed to a top side of the main body, according to some embodiments of the present disclosure.

FIG. 34 is a left, front perspective view of the exemplary extendable camper of FIG. 33, with its extension body pivoted away from the main body.

FIG. 35 is a right, front perspective view of the exemplary extendable camper of FIG. 34, with a slide-out in the main body extended.

FIG. 36 is a view of the exemplary extendable camper of FIG. 35, with openings in the extension body and main body in open positions.

FIG. 37 is a right, rear perspective view of the exemplary extendable camper of FIG. 35, showing an opening in the front side of the extension body in an open position.

While the disclosure is susceptible to various modifications and alternative forms, specific embodiments are shown by way of example in the drawings and described in detail. The description of particular embodiments herein is not intended to limit the disclosure to these forms; rather, the intention is to cover all modifications, equivalents, and alternatives falling within the spirit and scope of the disclosure as defined by the appended claims.

### DETAILED DESCRIPTION OF SPECIFIC EMBODIMENTS

Described herein are various devices, components, assemblies, systems, and methods related to extendable campers. The description and accompanying figures, which illustrate specific embodiments, are provided in a non-limiting manner to demonstrate several possible configurations of extendable campers, as well as associated apparatuses, components, assemblies, systems, and methods of use according to various aspects and features of the present disclosure.

Accordingly, the disclosure is not limited to the specific embodiments shown. Rather, the inventive principles discussed herein—including those relating to the apparatuses, devices, components, assemblies, systems, and methods—may be applied in numerous ways, including other types of apparatuses, devices, components, assemblies, systems, or methods. Both general and particular solutions are described in sufficient detail to enable one of ordinary skill in the art, after reading this disclosure, to develop various implementations and applications without undue experimentation.

In creating such implementations, a range of design-specific decisions will be made to meet particular objectives, and these may vary from one application to another. Having access to this disclosure, it will be apparent to persons skilled in the art that such development efforts would be routine.

This document does not intend to distinguish between components that differ in name but not function. In the following discussion and in the claims, the terms “including,” “includes,” “comprising,” “have,” and “has” are used in an open-ended fashion, and thus should be interpreted to mean “including, but not limited to.” The word “or” is used in the inclusive sense (i.e., “and/or”) unless a specific use to the contrary is explicitly stated.

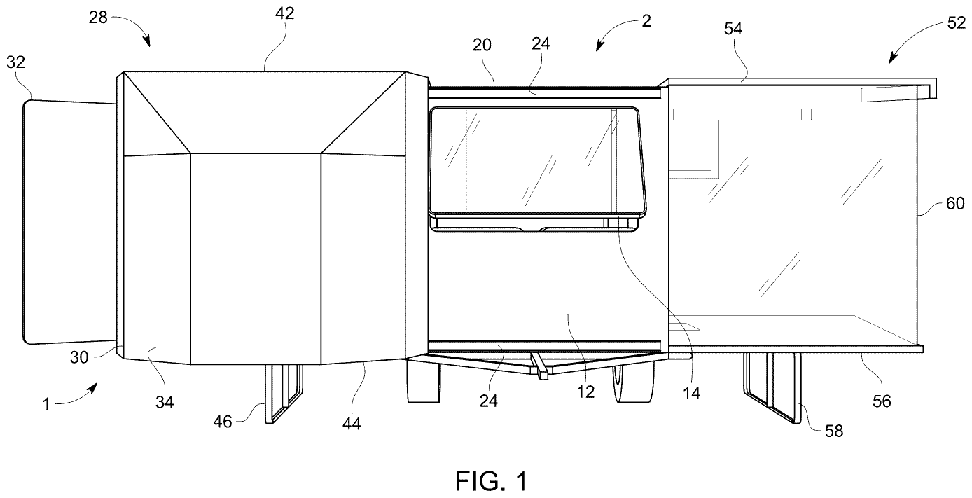

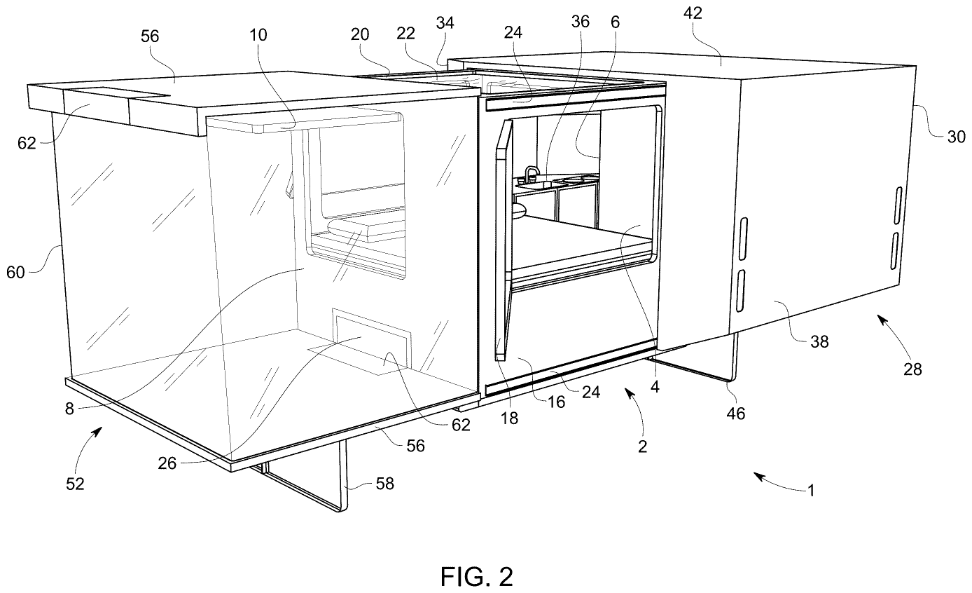

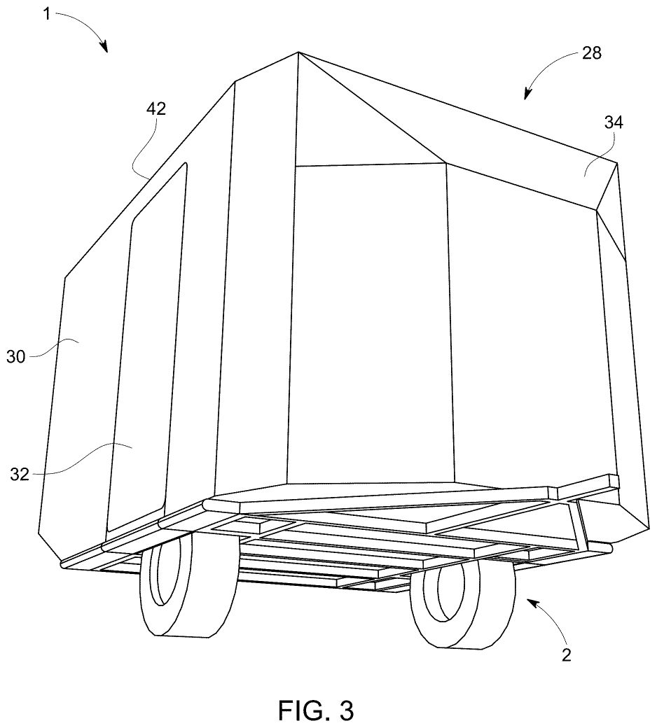

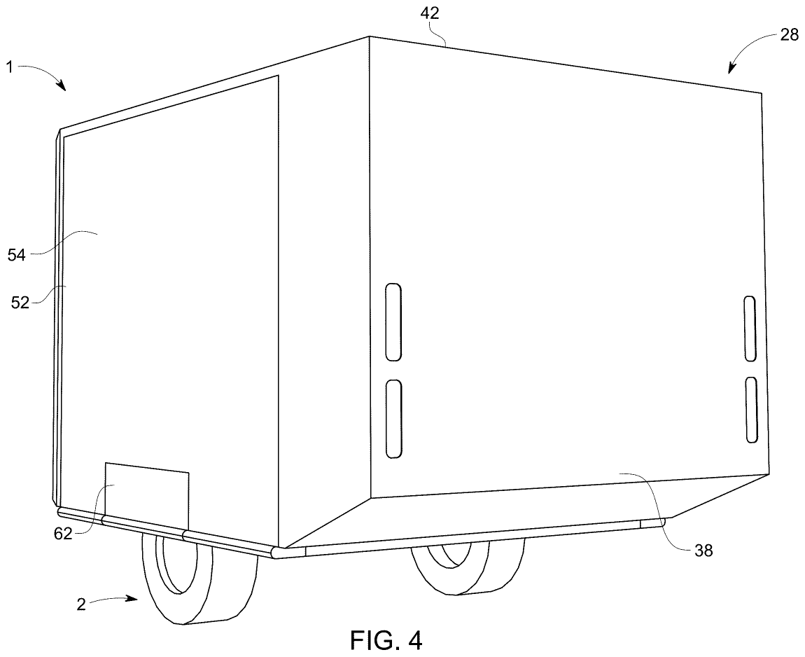

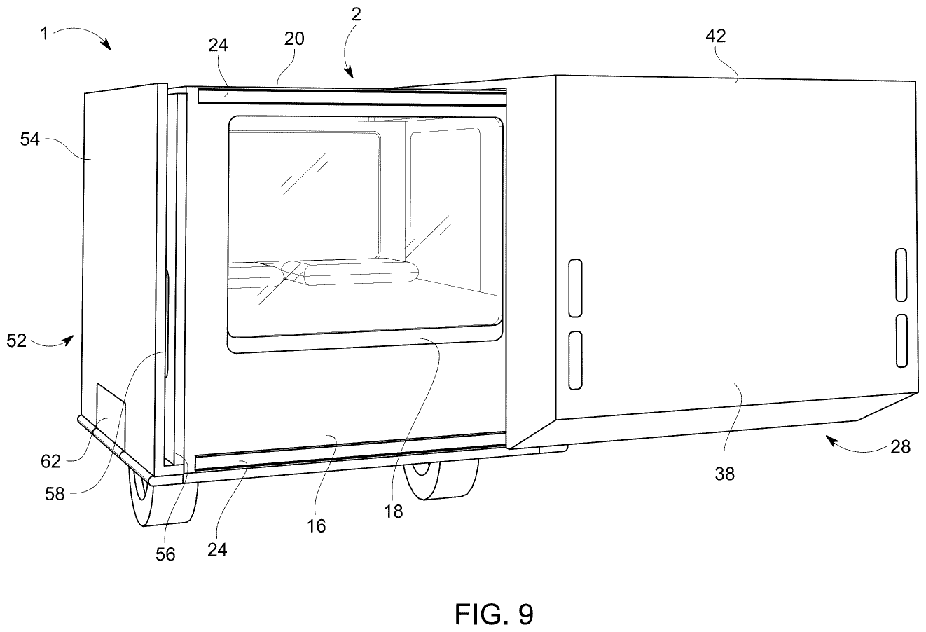

Extendable camper 1 and components thereof are shown in FIGS. 1-11. Extendable camper 1 may be comprised of main body 2, which may be a hard-sided camper body (e.g., as shown in FIGS. 1-5, and 9-11); a 1^{st} extension body, extension body 28, which may be a hard-sided extension body configured to move between a retracted position, where it is adjacent to main body 2 (e.g., as shown in FIGS. 3 and 4), and an extended position, where it is extended and pivoted away from main body 2 (e.g., as shown in FIGS. 1-2, and 9-11); a 2^{nd} extension body, extension body 52, which may be a hard-sided and soft-sided extension body configured to move between a retracted position, where it is adjacent to main body 2 (e.g., as shown in FIGS. 4, 9, and 10), and an extended position, where it is pivoted away from main body 2 (e.g., as shown in FIGS. 1, 2, and 11); where main body 2 and extension bodies 28 and 52 may each form an independent enclosure in both retracted and extended positions (e.g., are each independently sealed); where main body 2 is not dependent on extension bodies 28 or 52 to form a self-contained camper (e.g., main body 2 can function as a camper with or without extension bodies 28 or 52); and where side features (e.g., features in or on the sides of main body 2 and extension bodies 28 and 52) such as opening 6 in side 4 of main body 2, opening 10 in side 8 of main body 2, opening 14 in side 12 of main body 2, opening 18 in side 16 of main body 2, opening 22 in roof 20 of main body 2, opening 32 in side 30 of 1^{st} extension body 28, compartment 36 in side 34 of 1^{st} extension body 28, compartment 40 in side 38 of 1^{st} extension body 28, leg 46 on floor 44 of 1^{st} extension body 28, leg 58 on floor 56 of 2^{nd} extension body 52, tracks in roof 54 and floor 56 of 2^{nd} extension body 52 to install insect screen 60, and other openings, compartments, storage cabinets, kitchen fixtures, bathroom fixtures, utility fixtures, or other features or components that may be located in or on the sides of both main body 2 and extension bodies 28 and/or 52 that are adjacent to each other (e.g., in a retracted position, and may be blocked and inaccessible in that position, as shown in FIGS. 3 and 4) may be accessible in an extended position, as shown in FIGS. 1 and 2.

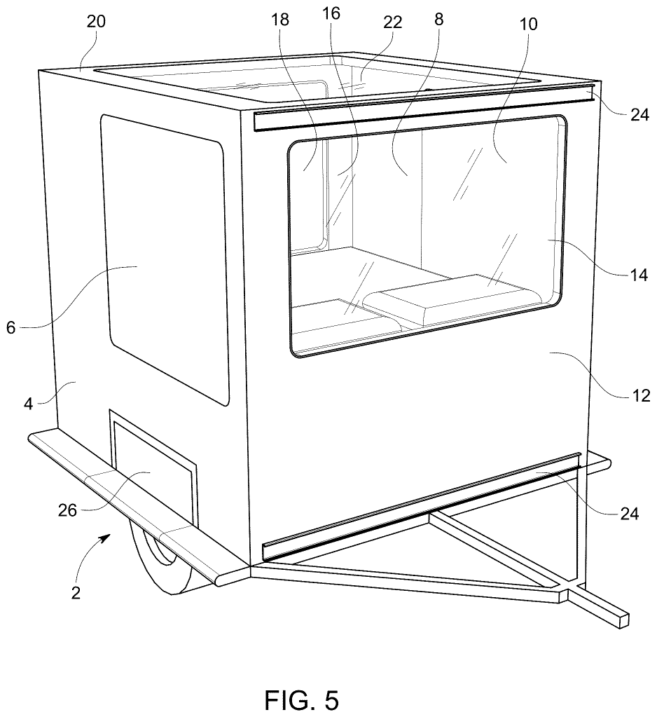

Extendable camper 1 may contain main body 2, which may be a hard-sided body that is self-contained and comprised of a frame; an interior living space; wheels and a chassis; a trailer tongue with a hitch coupler, jack, and/or other trailer components; and/or other components, as shown in FIGS. 1-5, and 9-11. Main body 2 may be fully sealed (e.g., from water and/or insects), forming an independent enclosure that is not dependent on either extension body 28 or extension body 52, as shown in FIG. 5. Main body 2 may contain in and/or on its sides (e.g., front, rear, left, right, and/or top sides) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures.

As shown in FIGS. 1-2, 5, and 9-11, main body 2 may contain: opening 6, which may be a door in side 4, which may be a right side; opening 10, which may be a door in side 8, which may be a left side; opening 14, which may be a window in side 12, which may be a front side; opening 18, which may be a window in side 16, which may be a rear side; and opening 22, which may be a window in side 20, which may be a roof. Main body 2 may contain a portion of one or more sliding mechanisms such as a fixed portion of one or more heavy-duty slides, where a sliding portion is inserted into the fixed portion, allowing the sliding portion to slide back and forth inside the fixed portion, further into or further out of the fixed portion, causing retraction or extension, respectively, of the slides. Alternatively, or in addition, main body 2 may contain a portion of one or more hinges, allowing a corresponding portion of the one or more hinges to be pivoted toward or away from main body 2, causing retraction or extension, respectively, of the hinges.

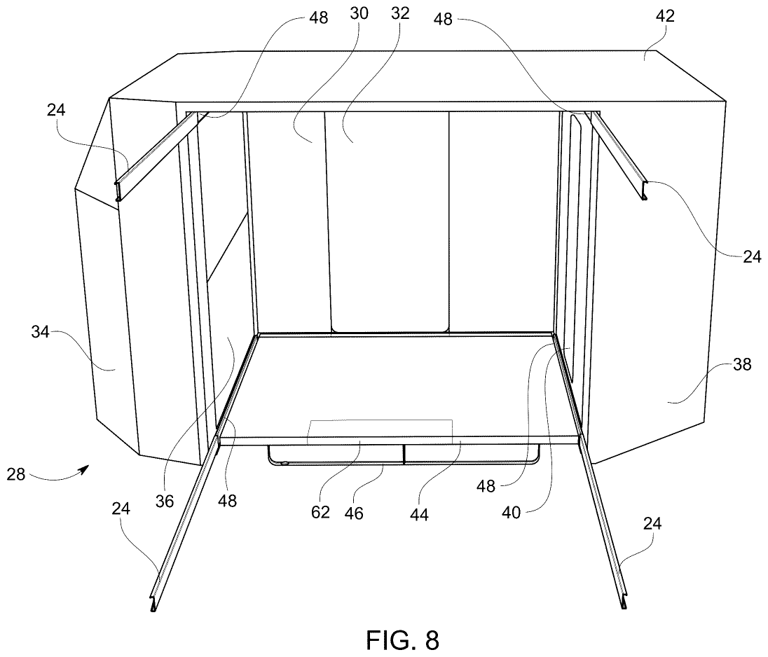

As shown in FIGS. 1-2, 5, and 9-11, main body 2 may contain four of fixed members 24, with two on side 12 and two on side 16, which may be the fixed portions of four heavy duty slides that contain the corresponding sliding portions on extension body 28, with two on side 34 and two on side 38, respectively, slidably connecting extension body 28 to main body 2. FIG. 8 shows how fixed members 24 of main body 2 may be connected to sliding members 48 of extension body 28, with main body 2 removed for clarity. In addition, as shown in FIGS. 1-2, and 9-11, main body 2 may also contain portions of hinges (individual hinges not shown) that may contain corresponding portions on extension body 52 and on a side of extension body 28, pivotably connecting extension body 52 and a side of extension body 28 to main body 2.

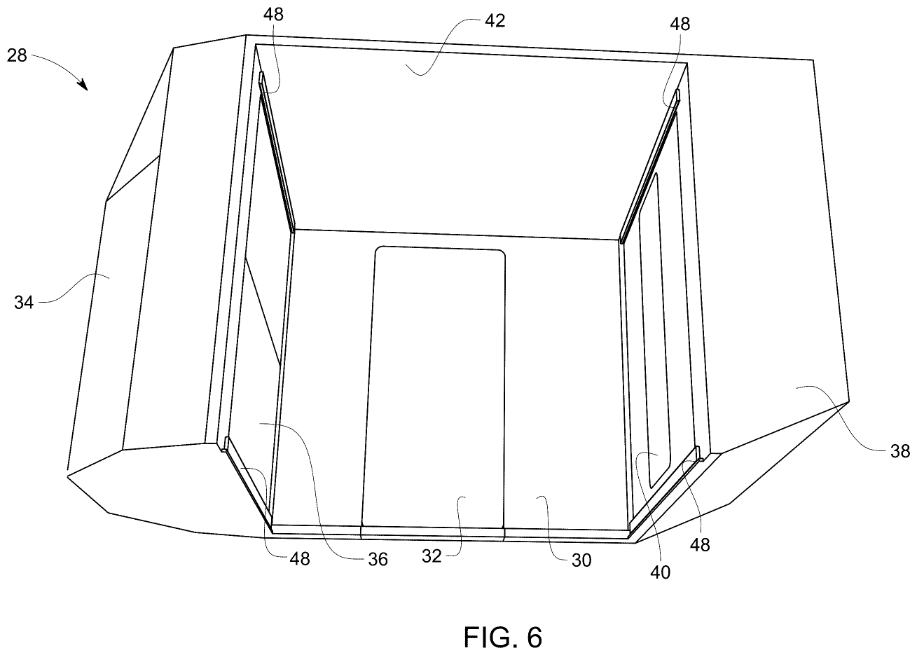

Main body 2 of extendable camper 1 may be configured such that extension body 28, which may be 1^{st} extension body configured as a hard-sided body, and extension body 52, which may be a 2^{nd} extension body and configured as a hard-and soft-sided body, may be slidably and/or pivotably attached to or adjacent to at least one of main body 2's external sides. A fixed portion of one or more slides and/or a portion of one or more hinges, which may be attached to main body 2, may allow extension bodies 28 and 52, which may contain a corresponding sliding portion of the one or more slides and/or a corresponding portion of the one or more hinges, respectively, to slide and/or pivot, respectively, away from or toward main body 2. As shown in FIGS. 6 and 8, extension body 28 may contain four of sliding members 48, with two on side 34 and two on side 38, which may be the sliding portions of four heavy duty slides that contain the corresponding fixed portions on main body 2, with two on side 12 and two on side 16, respectively, slidably connecting extension body 28 to main body 2.

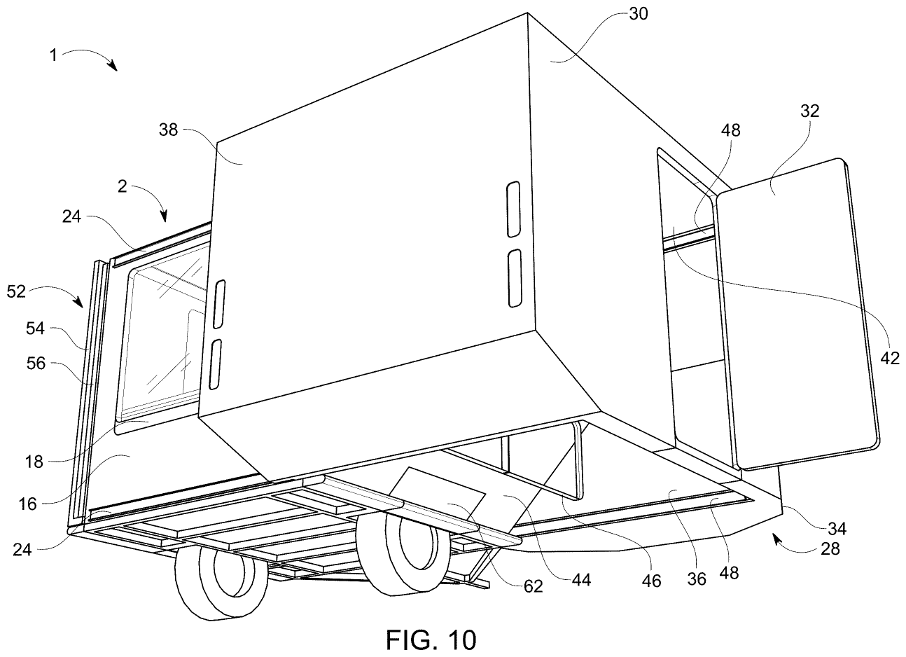

As mentioned previously, FIG. 8 shows how sliding members 48 of extension body 28 may be connected to fixed members 24 of main body 2, with main body 2 removed for clarity. In addition, and as shown in FIGS. 1-2, and 9-11, extension body 52 and a side of extension body 28 may also contain portions of hinges (not shown) that may contain corresponding portions on main body 2, pivotably connecting extension body 52 and a side of extension body 28 to main body 2. Extension bodies 28 and 52 may be configured to move between retracted positions, where one or more of their sides is adjacent to one or more sides, respectively, of main body 2, and extended positions, where they may be extended and/or pivoted away from main body 2, such that the one or more of their sides is not, or is not fully, adjacent to the one or more sides, respectively, of main body 2. Extension body 28 may be extendable by the one or more slides attaching it to main body 2, allowing extension body 28 to slide horizontally toward, as shown fully retracted in FIGS. 3 and 4, or away, as shown fully extended in FIGS. 1-2 and 9-11, from main body 2. And extension body 52 and side 44 of extension body 28 may be pivotable by the one or more hinges attaching them to main body 2, allowing extension body 52 and side 44 of extension body 28 to pivot toward (e.g., as shown in FIGS. 4, 9, and 10 for extension body 52, and in transition in FIG. 10 for side 44 of extension body 28) or away (e.g., as shown in FIGS. 1-2, and 11 for extension body 52 and side 44 of extension body 28, and in transition in FIG. 10 for side 44 of extension body 28) from main body 2. Extension body 28 may be fully sealed, forming an independent enclosure (e.g., may be or may contain one or more compartments, enclosures, or other internal components that is sealed from water and/or insects) and is not dependent on main body 2. Extension body 52 may be fully sealed or may not require sealing (e.g., if configured as a covered porch) to form an independent enclosure. Extension bodies 28 and 52 may contain in or on their sides (e.g., sides that face main body 2, face away from main body 2, or face another direction) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures.

As shown in FIGS. 1-2, 6-8, and 10-11, extension body 28 may contain: opening 32, which may be a door in side 30, which may be a right side; compartment 36, which may be a compartment containing kitchen fixtures in side 34, which may be a front side; compartment 40, which may be a storage compartment in side 38, which may be a rear side; lights or other components in side 42, which may be a roof; and leg 46, which may be a leg (pivotable by hinges) to support side 44, which may be a floor. Extension body 52 may contain: leg 58, which may be a leg (pivotable by hinges) to support side 56, which may be a floor, as shown in FIGS. 1-2; insect screen 60, which may be a soft-sided screen or fabric wall that may be detachably connected between side 54, which may be a roof, and side 56, which may be a floor, as shown installed in FIGS. 1-2.

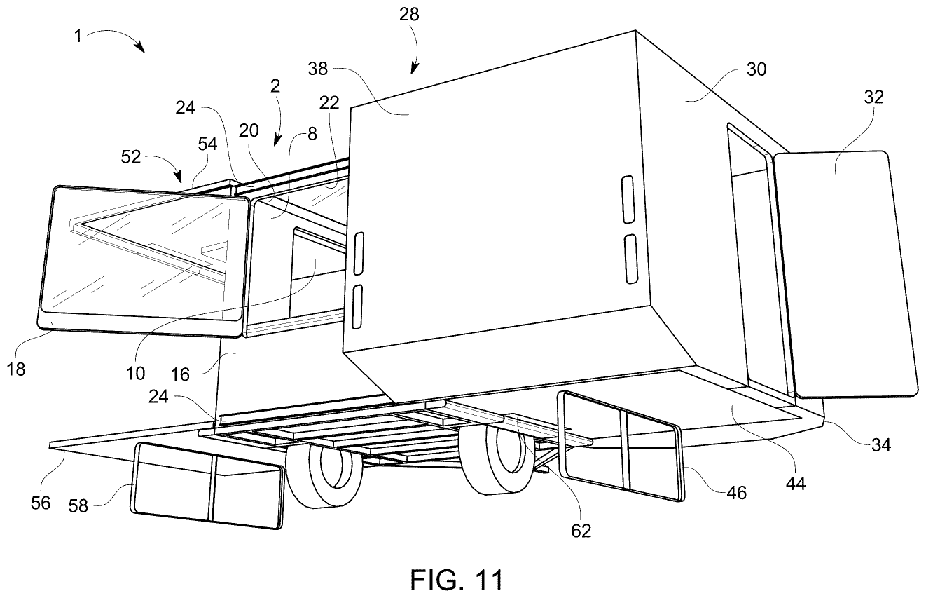

When extendable camper 1 is in a retracted position, as shown in FIGS. 3 and 4, one or more sides of main body 2 may be adjacent to one or more sides, respectively, of extension bodies 28 and/or 52, and access to those adjacent sides and/or features (e.g., as mentioned above) on those adjacent sides on each body may be blocked, however, when extendable camper 1 is in an extended position with extension body 28 extended away, as shown in FIGS. 1-2, and 9-11, and extension body 52 pivoted away, as shown in FIGS. 1-2, and 11, from main body 2, access to those adjacent sides and/or features on those adjacent sides of main body 2 and extension bodies 28 and/or 52 may now be gained. When extendable camper 1 is in an extended position, features on adjacent sides of main body 2, extension body 28, and/or extension body 52, which may include openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures may now be used, opened, exposed, extended, connected, and/or accessed. When extendable camper 1 is in an extended position as shown in FIGS. 1-2, opening 6, which may be a door in side 4, which may be a right side of main body 2, may be used for ingress or egress for main body 2; opening 10, which may be a door in side 8, which may be a left side of main body 2, may be used for ingress or egress for main body 2; opening 14, which may be a window in side 12, which may be a front side of main body 2, may be used to ventilate, or to view into or out of main body 2; opening 18, which may be a window in side 16, which may be a rear side of main body 2, may be used for ventilation, or to view into or out of main body 2; opening 22, which may be a window in side 20, which may be a roof of main body 2, may be used for ventilation, or to view into or out of main body 2; opening 32, which may be a door in side 30, which may be a right side of extension body 28, may be used for ingress or egress for extension body 28; compartment 36, which may be a compartment containing kitchen fixtures in side 34, which may be a front side of extension body 28, may be opened and used as a kitchen or closed to keep food and/or other kitchen items in a sealed enclosure; compartment 40, which may be a storage compartment in side 38, which may be a rear side of extension body 28, may be opened to access stored items or closed to keep stored items in a sealed enclosure; lights or other components in side 42, which may be a roof of extension body 28, may be used to light up portions of extension body 28, or for other purposes; leg 46, which may be a leg to support side 44, which may be a floor of extension body 28, may be extended and/or pivoted to provide support to floor 44; leg 58, which may be a leg to support side 56, which may be a floor of extension body 52, may be extended and/or pivoted to provide support to floor 56; and insect screen 60, which may be a soft-sided screen or fabric wall may be detachably connected between side 54, which may be a roof, and side 56, which may be a floor of extension body 28 to provide shelter from insects, or if not installed, as shown in FIG. 11, sides 54 and 56 may be used as a covered porch.

As is the case with extendable camper 1 and as mentioned, main body 2 may be attached to a 1^{st} extension body, extension body 28, and a 2^{nd} extension body, extension body 52; where main body 2 and extension body 28 may have 4 pairs of respective, adjacent sides (e.g., located at or near the front, rear, and top sides of main body 2), and 1 set of respective, adjacent sides, where main body 2 may be attached to and/or adjacent to two of sides of extension body 28 (e.g., on a right side of main body 2), when extension body 28 is in a retracted position, as shown in FIGS. 3 and 4; and where main body 2 and extension body 52 may also have 1 set of respective, adjacent sides where main body 2 may be attached to and/or adjacent to two sides of extension body 52 (e.g., on a left side of main body 2), when extension body 52 is in a retracted position, as shown in FIGS. 4, 9, and 10. Additionally, portions of the frame of main body 2, if present, such as the tongue in the front, a bumper at the rear, and/or running boards or rock sliders (e.g., parts of the frame that protect the main body, when off-road, from large rocks) on each side, which may extend beyond the sides of main body 2, may also be adjacent to portions of extension bodies 28 and/or 52. With extension bodies 28 and 52 extended and/or pivoted away from main body 2, as shown in FIGS. 1, 2, and 11, features in or on each pair or set of adjacent sides of main body 2 and extension bodies 28 and 52 (e.g., features on the adjacent sides of main body 2 and extension bodies 28 and/or 52 that abut or face each other in a retracted position, as shown in FIGS. 3 and 4, where those features may be blocked or inaccessible in that position), as mentioned previously, or portions of the frame of main body 2 that extend beyond the sides of main body 2 and are adjacent to portions of extension bodies 28 and/or 52 (e.g., when in a retracted position) may now be accessible. With extension bodies 28 and 52 in a retracted position, adjacent to main body 2, extendable camper 1 may have a smaller footprint (e.g., reduced length and/or width), which may be preferrable or necessary for transportation and/or storage.

Additionally, the surfaces of sides 34, 38, 30, and 42 of extension body 28, and the surface of side 54 of extension body 52 that abut or face sides 12, 16, 4, 20, and 8, respectively, of main body 2 (e.g., when retracted), may have a greater surface area, be flatter, or have other beneficial features for use when compared with the outward-facing surfaces of the same sides, allowing for larger openings on those surfaces (e.g., to compartments 36 and 38, respectively), or flatter, or more beneficial interior surfaces (e.g., of sides 30, 42, and 54, respectively) for use (e.g., when extended); while the outward-facing surfaces (e.g., outward-facing surfaces of sides 34, 38, 30, 42, and 54, respectively, that do not abut or face sides 12, 16, 4, 20, and 8, respectively, of main body 2) may have surfaces with certain shapes and/or other features that are beneficial for transportation (e.g., when retracted) such as: an outward-facing surface of front side 34 being angled inward, toward the front, for better aerodynamics; an outward facing surface of rear side 38 being angled upward from the bottom for a better departure angle (e.g., if extendable camper 1 is traversing steep slopes or bumps); and outward-facing surfaces of right side 30, roof 42, and roof 54 being flat and/or ruggedized (e.g., for protection of extendable camper 1 from rocks, tree limbs, and/or brush while traversing tight road or trails), and/or containing other features for improved aerodynamics or performance while extendable camper 1 is in transit, both on and off road.

With extension bodies 28 and 52 extended and/or pivoted away from main body 2 of extendable camper 1, one or more sides of extension bodies 28 or 52, individually; together with one or more other sides of extension bodies 28 or 52, respectively; or together with one or more sides of main body 2, which may be the one or more sides of main body 2 that were adjacent to the one or more respective sides of extension bodies 28 or 52, when in a retracted position, or may be different sides of main body 2, may form one or more additional full or partial enclosures of extendable camper 1. For example, some sides from the following pairs of sides or sets of sides (e.g., if there is one side of main body 2 that is adjacent to more than one side of extension body 28) which may be adjacent to each other when extension body 28 is in a retracted position, as shown in FIGS. 3 and 4: side 4 of main body 2 and side 30 of extension body 28, side 12 of main body 2 and side 34 of extension body 28, side 16 of main body 2 and side 38 of extension body 28, and side 20 of main body 2 and sides 42 and 44 of extension body 28; may, when extension body 28 is in an extended position, form a full or partial enclosure to the right side of extendable camper 1, as shown in FIGS. 1, 2, 9, and 11, comprised of: side 4 of main body 2, and sides 30, 34, 38, 42, and 44 of extension body 28. Similarly, some sides from the following pair of sides or set of sides (e.g., if there is one side of main body 2 that is adjacent to more than one side of extension body 52) which may be adjacent to each other when extension body 52 is in a retracted position, as shown in FIGS. 3 and 4: side 8 of main body 2 and sides 42 and 44 of extension body 52; may, when extension body 52 is in an extended position, form a full or partial enclosure to the left side of extendable camper 1, as shown in FIGS. 1, 2, and 11, comprised of: side 8 of main body 2, and sides 54 and 56 of extension body 52.

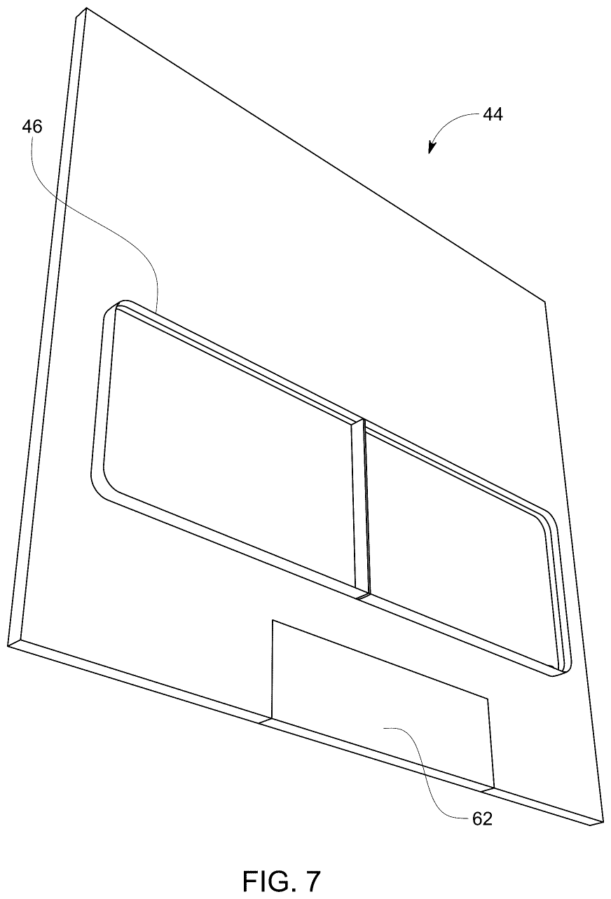

With extendable camper 1 having additional full or partial enclosures when extended, as shown in FIGS. 1, 2, and 11, the following side features may be more fully or partially sheltered and accessed from within the additional enclosures: opening 6 in side 4 of main body 2, opening 10 in side 8 of main body 2, compartment 36 in side 34 of extension body 28, compartment 40 in side 38 of extension body 28, the bottom side of roof 42 and the top side of floor 44 of extension body 28, and the bottom side of roof 54 and the top side of floor 56 of extension body 52. Removable wheel covers 26 of sides 4 and 8 of main body 2 (e.g., as shown in FIGS. 1 and 5) may cover the gaps in the wheels wells of sides 4 and 8, respectively, to further enclose any full or partial enclosures of extendable camper 1, when it is in an extended position, and removed in order to change a tire; and removable sections 62 in floor 44 in extension body 28 (e.g., as shown in FIGS. 7, 8, 10, and 11), and roof 54 and floor 56 in extension body 52 (e.g., as shown in FIGS. 2, 4, and 9) may also be removed to change a tire.

Extendable camper 1 may be extended, pivoted, or retracted manually, by powered means, or by a combination of manual and powered means. Extension bodies 28 and 52 that may be extendably connected to main body 2 may be extended, pivoted, and/or retracted by: powered means with actuators or motors; manually-assisted means with gas springs or struts, or with other types of springs or aids; or manual means, with a person pulling, pushing, pivoting, or moving extension bodies 28 and/or 52. If extension bodies 28 and/or 52 or portions of them are extendably connected to main body 2 with slides, the slides may contain locks and/or latches and/or other parts of extension bodies 28 and/or 52 and/or main body 2 may contain locks and/or latches to secure extension bodies 28 and/or 52, respectively, at certain positions (e.g., a retracted position, an extended position, or positions between a fully retracted and fully extended position), until and unless the locks and/or latches are unlocked and/or unlatched, respectively. Similarly, if extension bodies 28 and/or 52 or portions of them are pivotably connected to main body 2 with hinges, the hinges and/or pivoting mechanism may contain locks and/or latches and/or other parts of extension bodies 28 and/or 52 and/or main body 2 may contain locks and/or latches to secure the extension bodies 28 and/or 52, respectively, at certain positions (e.g., a retracted position, a pivoted position, or positions between a fully retracted and fully pivoted position), until and unless the locks and/or latches are unlocked and/or unlatched, respectively.

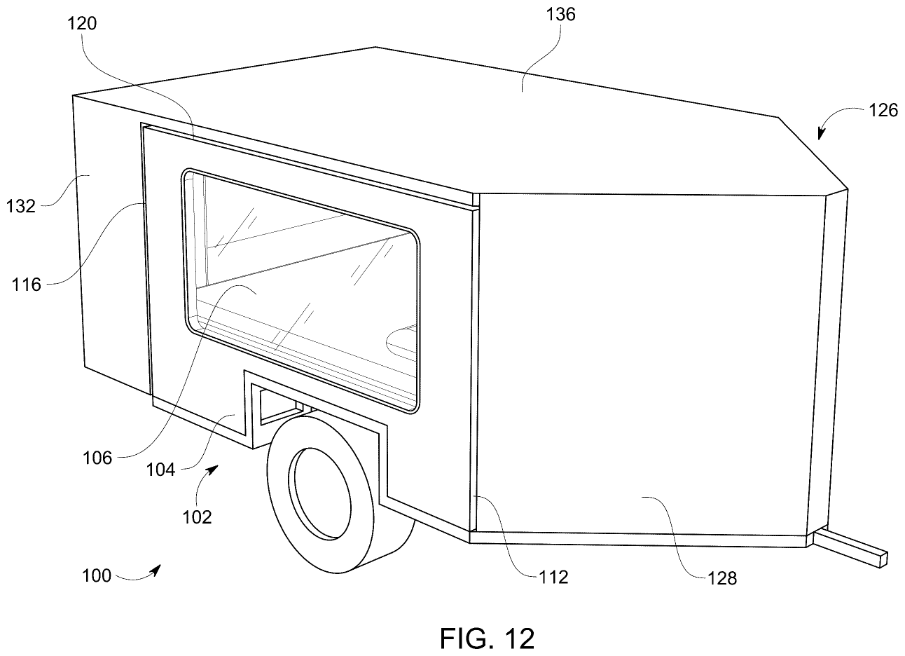

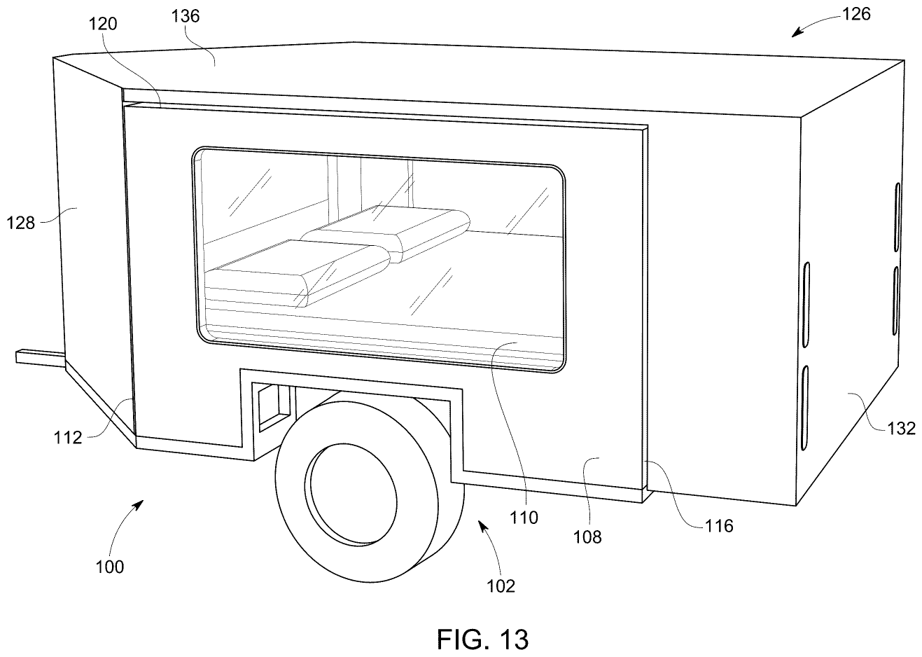

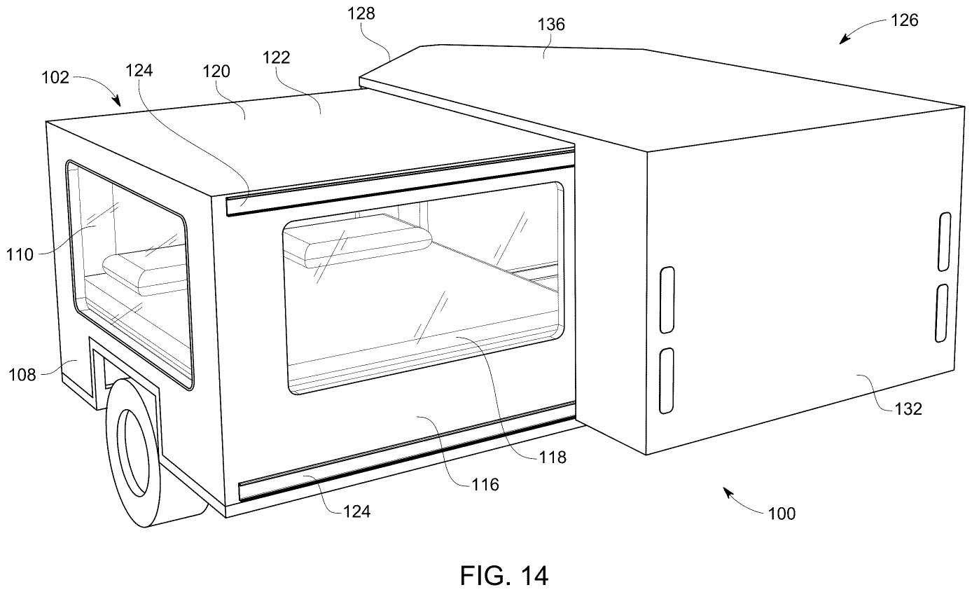

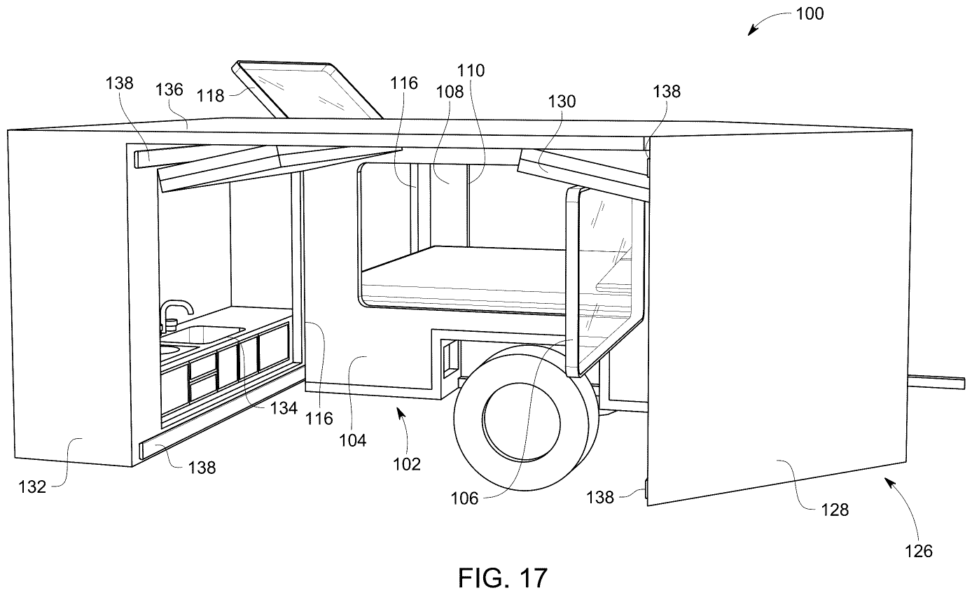

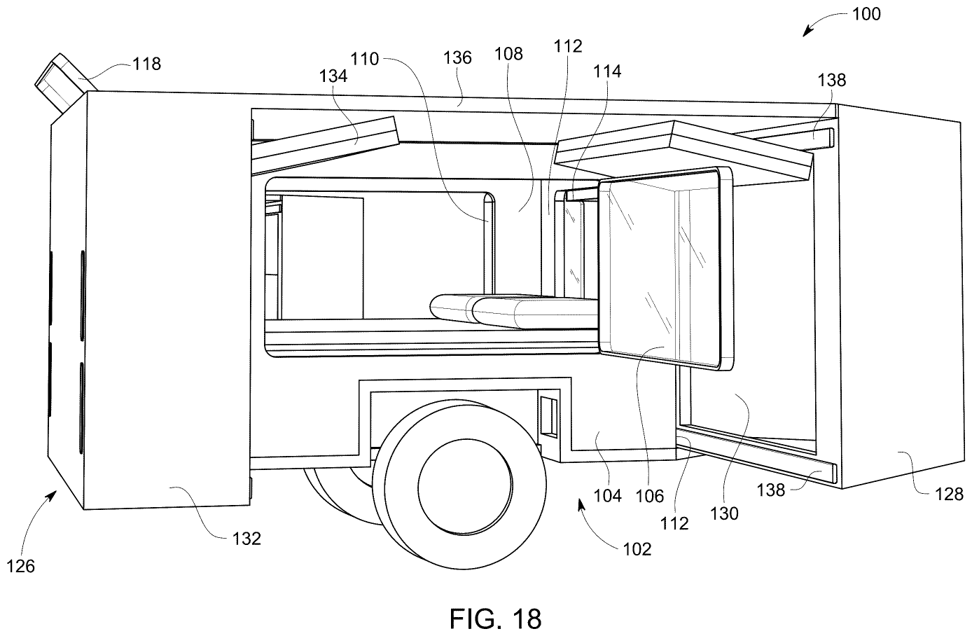

Extendable camper 100 and components thereof are shown in FIGS. 12-18. Extendable camper 100 may be comprised of main body 102, which may be a hard-sided camper body (e.g., as shown in FIGS. 12-18); and extension body 126, which may be a hard-sided extension body configured to move between a retracted position, where it is adjacent to main body 102 (e.g., as shown in FIGS. 12 and 13), and an extended position, where it is extended away from main body 102 (e.g., as shown in FIGS. 14-18); where main body 102 and extension body 126 may each form an independent enclosure in both retracted and extended positions (e.g., are each independently sealed); where main body 102 is not dependent on extension body 126 to form a self-contained camper (e.g., main body 102 can function as a camper with or without extension body 126); and where side features (e.g., features in or on the sides of main body 102 and extension body 126) such as opening 114 in side 112 of main body 102, opening 118 in side 116 of main body 102, opening 122 in roof 120 of main body 102, compartment 130 in side 128 of extension body 126, compartment 134 in side 132 of extension body 126, and other openings, compartments, storage cabinets, kitchen fixtures, bathroom fixtures, utility fixtures, or other features or components that may be located in or on the sides of both main body 102 and extension body 126 that are adjacent to each other (e.g., in a retracted position, and may be blocked and inaccessible in that position, as shown in FIGS. 12 and 13) may be accessible in an extended position, as shown in FIGS. 14-18.

Extendable camper 100 may contain main body 102, which may be a hard-sided body that is self-contained and comprised of a frame; an interior living space; wheels and a chassis; a trailer tongue with a hitch coupler, jack, and/or other trailer components; and/or other components, as shown in FIGS. 12-18. Main body 102 may be fully sealed (e.g., from water and/or insects), forming an independent enclosure that is not dependent on extension body 126. Main body 102 may contain in and/or on its sides (e.g., front, rear, left, right, and/or top sides) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures.

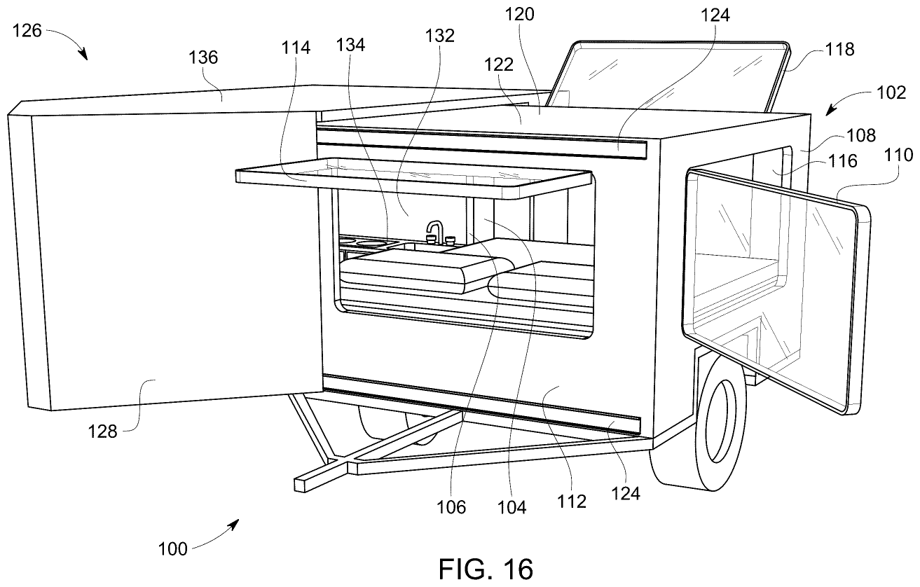

As shown in FIGS. 12-18, main body 102 may contain: opening 106, which may be a door in side 104, which may be a right side; opening 110, which may be a door in side 108, which may be a left side; opening 114, which may be a window in side 112, which may be a front side; opening 118, which may be a window in side 116, which may be a rear side; and opening 122, which may be a window in side 120, which may be a roof. Main body 102 may contain a portion of one or more sliding mechanisms such as a fixed portion of one or more heavy-duty slides, where a sliding portion is inserted into the fixed portion, allowing the sliding portion to slide back and forth inside the fixed portion, further into or further out of the fixed portion, causing retraction or extension, respectively, of the slides. As shown in FIGS. 14 and 16, main body 102 may contain four of fixed members 124, with two on side 112 and two on side 116, which may be the fixed portions of four heavy duty slides that contain the corresponding sliding portions on extension body 126, with two on side 128 and two on side 132, respectively, slidably connecting extension body 126 to main body 102, as shown extended in FIGS. 14-18.

Main body 102 of extendable camper 100 may be configured such that extension body 126, which may be an extension body configured as a hard-sided body, may be slidably attached to or adjacent to at least one of main body 102's external sides. A fixed portion of one or more slides, which may be attached to main body 102, may allow extension body 126, which may contain a corresponding sliding portion of the one or more slides, respectively, to slide away from or toward main body 102.

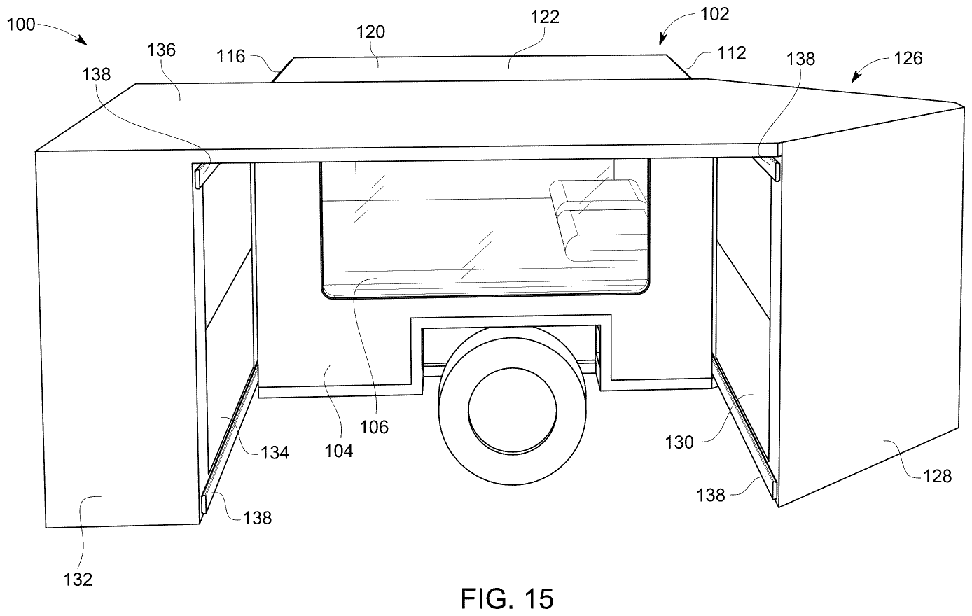

As shown in FIGS. 15, 17, and 18, extension body 126 may contain four of sliding members 138, with two on side 128 and two on side 132, which may be the sliding portions of four heavy duty slides that contain the corresponding fixed portions on main body 102, with two on side 112 and two on side 116, respectively, slidably connecting extension body 126 to main body 102. Extension body 126 may be configured to move between a retracted position, where one or more of its sides is adjacent to one or more sides, respectively, of main body 102, and an extended position, where it may be extended away from main body 102, such that the one or more of its sides is not, or is not fully, adjacent to the one or more sides, respectively, of main body 102. Extension body 126 may be extendable by the one or more slides attaching it to main body 102, allowing extension body 126 to slide horizontally toward, as shown fully retracted in FIGS. 12 and 13, or away, as shown fully extended in FIGS. 14-18, from main body 102. Extension body 126 may be fully sealed, forming an independent enclosure (e.g., may be or may contain one or more compartments, enclosures, or other internal components that is sealed from water and/or insects) and is not dependent on main body 102. Extension body 126 may contain in or on its sides (e.g., sides that face main body 102, face away from main body 102, or face another direction) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures.

As shown in FIGS. 12-18, extension body 126 may contain: compartment 130, which may be a storage compartment in side 128, which may be a front side; compartment 134, which may be a compartment containing kitchen fixtures in side 132, which may be a rear side; and lights or other components in side 136, which may be a roof.

When extendable camper 100 is in a retracted position, as shown in FIGS. 12 and 13, one or more sides of main body 102 may be adjacent to one or more sides, respectively, of extension body 126, and access to those adjacent sides and/or features (e.g., as mentioned above) on those adjacent sides on each body may be blocked, however, when extendable camper 100 is in an extended position with extension body 126 extended away, as shown in FIGS. 14-18, from main body 102, access to those adjacent sides and/or features on those adjacent sides of main body 102 and extension body 126 may now be gained. When extendable camper 100 is in an extended position, features on adjacent sides of main body 102, and/or extension body 126, which may include openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures may now be used, opened, exposed, extended, connected, and/or accessed. When extendable camper 100 is in an extended position as shown in FIGS. 14-18, opening 114, which may be a window in side 112, which may be a front side of main body 102, may be used to ventilate, or to view into or out of main body 102; opening 118, which may be a window in side 116, which may be a rear side of main body 102, may be used for ventilation, or to view into or out of main body 102; opening 122, which may be a window in side 120, which may be a roof of main body 102, may be used for ventilation, or to view into or out of main body 102; compartment 130, which may be a storage compartment in side 128, which may be a front side of extension body 126, may be opened to access stored items or closed to keep stored items in a sealed enclosure; compartment 134, which may be a compartment containing kitchen fixtures in side 132, which may be a rear side of extension body 126, may be opened and used as a kitchen or closed to keep food and/or other kitchen items in a sealed enclosure; and lights or other components in side 136, which may be a roof of extension body 126, may be used to light up portions of extension body 126, or for other purposes. Whether extendable camper 100 is in a retracted position (e.g., as shown in FIGS. 12-13) or extended position (e.g., as shown in FIGS. 14-18), opening 106, which may be a door in side 104, which may be a right side of main body 102, may be used for ingress or egress for main body 102; and opening 110, which may be a door in side 108, which may be a left side of main body 102, may be used for ingress or egress for main body 102.

As is the case with extendable camper 100 and as mentioned, main body 102 may be attached to extension body 126; where main body 102 and extension body 126 may have 3 pairs of respective, adjacent sides (e.g., located at or near the front, rear, and top sides of main body 102), when extension body 126 is in a retracted position, as shown in FIGS. 12 and 13. Additionally, portions of the frame of main body 102, if present, such as the tongue in the front, and/or a bumper at the rear, which may extend beyond the sides of main body 102, may also be adjacent to portions of extension body 126. With extension body 126 extended away from main body 102, as shown in FIGS. 14-18, features in or on each pair of adjacent sides of main body 102 and extension body 126 (e.g., features on the adjacent sides of main body 102 and extension body 126 that abut or face each other in a retracted position, as shown in FIGS. 12 and 13, where those features may be blocked or inaccessible in that position), as mentioned previously, or portions of the frame of main body 102 that extend beyond the sides of main body 102 and are adjacent to portions of extension body 126 (e.g., when in a retracted position) may now be accessible. With extension body 126 in a retracted position, adjacent to main body 102, extendable camper 100 may have a smaller footprint (e.g., reduced length and/or width), which may be preferrable or necessary for transportation and/or storage. Additionally, the surfaces of sides 128, 132, and 136 of extension body 126 that abut or face sides 112, 116, and 120, respectively, of main body 102 (e.g., when retracted), may have a greater surface area, be flatter, or have other beneficial features for use when compared with the outward-facing surfaces of the same sides, allowing for larger openings on those surfaces (e.g., to compartments 130 and 134, respectively), or flatter, or more beneficial interior surfaces (e.g., of side 120, respectively) for use (e.g., when extended); while the outward-facing surfaces (e.g., outward-facing surfaces of sides 128, 132, and 136, respectively, that do not abut or face sides 112, 116, and 120, respectively, of main body 102) may have surfaces with certain shapes and/or other features that are beneficial for transportation (e.g., when retracted) such as: an outward-facing surface of front side 128 being angled inward, toward the front, for better aerodynamics; an outward facing surface of rear side 132 containing taillights, as may be required by vehicular laws and regulations; and the outward-facing surface of roof 136 being flat, and/or ruggedized (e.g., for protection of extendable camper 100 from rocks, tree limbs, and/or brush while traversing tight road or trails), and/or containing other features for improved aerodynamics or performance while extendable camper 100 is in transit, both on and off road.

With extension body 126 extended away from main body 102 of extendable camper 100, one or more sides of extension body 126, individually; together with one or more other sides of extension body 126; or together with one or more sides of main body 102, which may be the one or more sides of main body 102 that were adjacent to the one or more respective sides of extension body 126, when in a retracted position, or may be different sides of main body 102, may form one or more additional full or partial enclosures of extendable camper 100. For example, some sides from the following pairs of sides or sets of sides (e.g., if there is one side of main body 102 that is adjacent to more than one side of extension body 126) which may be adjacent to each other when extension body 126 is in a retracted position, as shown in FIGS. 12 and 13: side 112 of main body 102 and side 128 of extension body 126, side 116 of main body 102 and side 132 of extension body 126, and side 120 of main body 102 and side 136 of extension body 126; may, when extension body 126 is in an extended position, form a full or partial enclosure to the right side of extendable camper 100, as shown in FIGS. 14-18, comprised of: side 104 of main body 102, and sides 128, 132, and 136 of extension body 126. With extendable camper 100 having an additional full or partial enclosure when extended, as shown in FIGS. 14-18, the following side features may be more fully or partially sheltered and accessed from within the additional enclosure: opening 106 in side 104 of main body 102, compartment 130 in side 128 of extension body 126, compartment 134 in side 132 of extension body 126, and the bottom side of roof 136 of extension body 126.

Extendable camper 100 may be extended or retracted manually, by powered means, or by a combination of manual and powered means. Extension body 126 that may be extendably connected to main body 102 may be extended or retracted by: powered means with actuators or motors; manually-assisted means with gas springs or struts, or with other types of springs or aids; or manual means, with a person pulling, pushing, or moving extension body 126. The slides connecting extension body 126 to main body 102 may contain locks and/or latches and/or other parts of extension body 126, and/or main body 102 may contain locks and/or latches to secure extension body 126 at certain positions (e.g., a retracted position, an extended position, or positions between a fully retracted and fully extended position), until and unless the locks and/or latches are unlocked and/or unlatched, respectively.

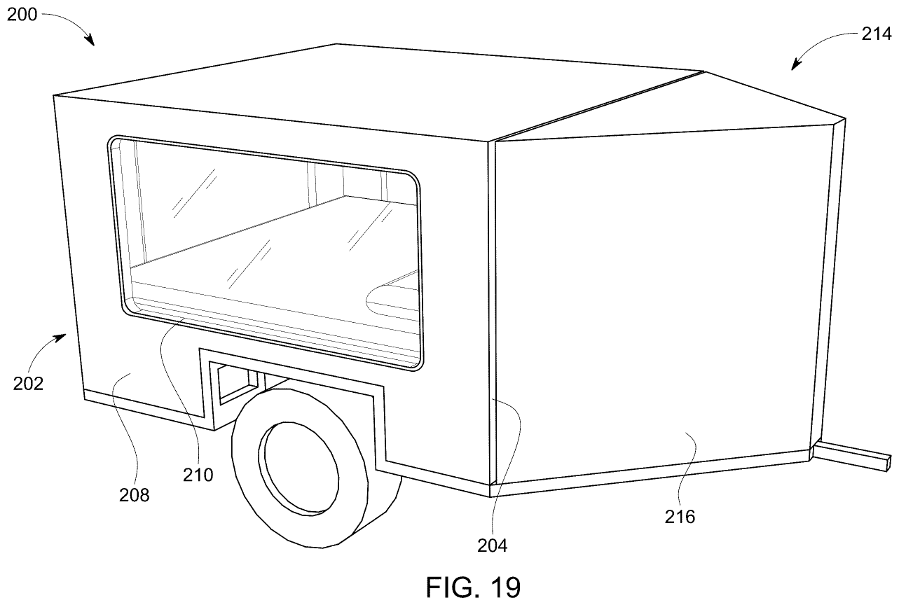

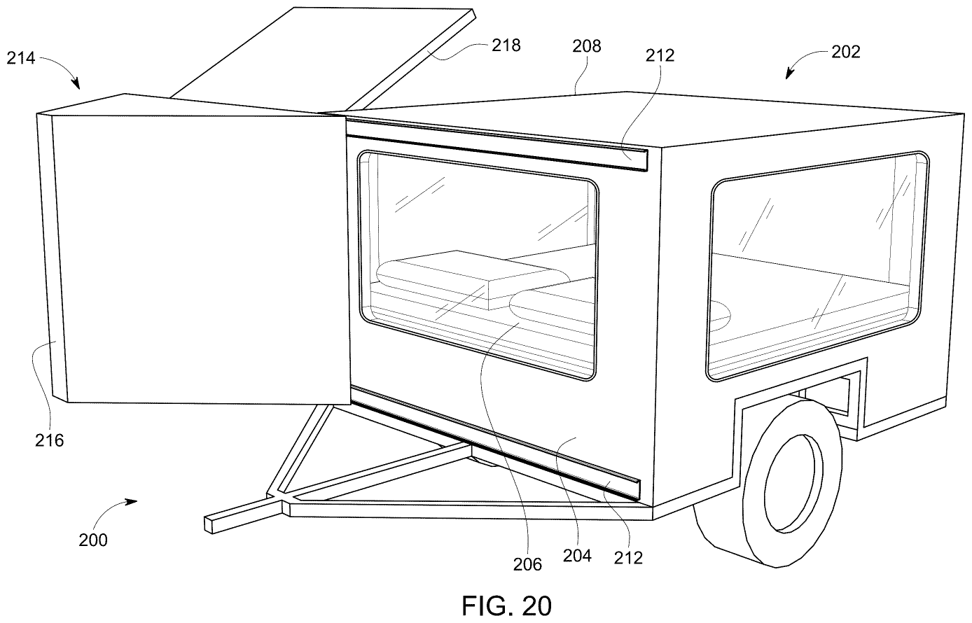

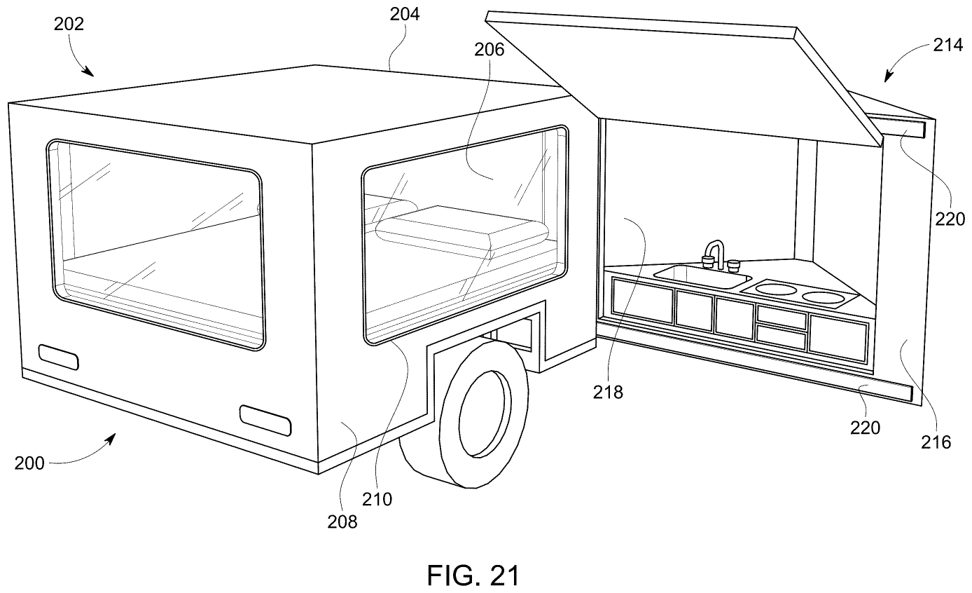

Extendable camper 200 and components thereof are shown in FIGS. 19-21. Extendable camper 200 may be comprised of main body 202, which may be a hard-sided camper body (e.g., as shown in FIGS. 19-21); and extension body 214, which may be a hard-sided extension body configured to move between a retracted position, where it is adjacent to main body 202 (e.g., as shown in FIG. 19), and an extended position, where it is extended away from main body 202 (e.g., as shown in FIGS. 20 and 21); where main body 202 and extension body 214 may each form an independent enclosure in both retracted and extended positions (e.g., are each independently sealed); where main body 202 is not dependent on extension body 214 to form a self-contained camper (e.g., main body 202 can function as a camper with or without extension body 214); and where side features (e.g., features in or on the sides of main body 202 and extension body 214) such as opening 206 in side 204 of main body 202, and compartment 218 in side 216 of extension body 214, and other openings, compartments, storage cabinets, kitchen fixtures, bathroom fixtures, utility fixtures, or other features or components that may be located in or on the sides of both main body 202 and extension body 214 that are adjacent to each other (e.g., in a retracted position, and may be blocked and inaccessible in that position, as shown in FIG. 19) may be accessible in an extended position, as shown in FIGS. 20 and 21.

Extendable camper 200 may contain main body 202, which may be a hard-sided body that is self-contained and comprised of a frame; an interior living space; wheels and a chassis; a trailer tongue with a hitch coupler, jack, and/or other trailer components; and/or other components, as shown in FIGS. 19-21. Main body 202 may be fully sealed (e.g., from water and/or insects), forming an independent enclosure that is not dependent on extension body 214. Main body 202 may contain in and/or on its sides (e.g., front, rear, left, right, and/or top sides) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures.

As shown in FIGS. 19-21, main body 202 may contain: opening 206, which may be window in side 204, which may be a front side; and opening 210, which may be a door in side 208, which may be a right side. Main body 202 may contain a portion of one or more sliding mechanisms such as a fixed portion of one or more heavy-duty slides, where a sliding portion is inserted into the fixed portion, allowing the sliding portion to slide back and forth inside the fixed portion, further into or further out of the fixed portion, causing retraction or extension, respectively, of the slides. As shown in FIG. 20, main body 202 may contain two fixed members 212 on side 204, which may be the fixed portions of two heavy duty slides that contain the corresponding sliding portions on extension body 214 on side 216, slidably connecting extension body 214 to main body 202, as shown extended in FIGS. 20 and 21.

Main body 202 of extendable camper 200 may be configured such that extension body 214, which may be an extension body configured as a hard-sided body, may be slidably attached to or adjacent to at least one of main body 202's external sides. A fixed portion of one or more slides, which may be attached to main body 202, may allow extension body 214, which may contain a corresponding sliding portion of the one or more slides, respectively, to slide away from or toward main body 202. As shown in FIG. 21, extension body 214 may contain two sliding members 220 on side 216, which may be the sliding portions of two heavy duty slides that contain the corresponding fixed portions on main body 202 on side 204, slidably connecting extension body 214 to main body 202. Extension body 214 may be configured to move between a retracted position, where one of its sides is adjacent to one side of main body 202, and an extended position, where it may be extended away from main body 202, such that none of its sides is, or is fully, adjacent to a side of main body 202. Extension body 214 may be extendable by the one or more slides attaching it to main body 202, allowing extension body 214 to slide horizontally toward, as shown fully retracted in FIG. 19, or away, as shown fully extended in FIGS. 20 and 21, from main body 202. Extension body 214 may be fully sealed, forming an independent enclosure (e.g., may be or may contain one or more compartments, enclosures, or other internal components that is sealed from water and/or insects) and is not dependent on main body 202. Extension body 214 may contain in or on its sides (e.g., sides that face main body 202, face away from main body 202, or face another direction) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures. As shown in FIG. 21, extension body 214 may contain compartment 218, which may be a compartment containing kitchen fixtures in side 216, which may be a front side.

When extendable camper 200 is in a retracted position, as shown in FIG. 19, a side of main body 202 may be adjacent to a side of extension body 214, and access to those adjacent sides and/or features (e.g., as mentioned above) on those adjacent sides on each body may be blocked, however, when extendable camper 200 is in an extended position with extension body 214 extended away, as shown in FIGS. 20 and 21, from main body 202, access to those adjacent sides and/or features on those adjacent sides of main body 202 and extension body 214 may now be gained. When extendable camper 200 is in an extended position, features on adjacent sides of main body 202, and/or extension body 214, which may include openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures may now be used, opened, exposed, extended, connected, and/or accessed. When extendable camper 200 is in an extended position as shown in FIGS. 20 and 21, opening 206, which may be a window in side 204, which may be a front side of main body 202, may be used to ventilate, or to view into or out of main body 202; and compartment 218, which may be a compartment containing kitchen fixtures in side 216, which may be a front side of extension body 214, may be opened and used as a kitchen or closed to keep food and/or other kitchen items in a sealed enclosure. Whether extendable camper 200 is in a retracted position (e.g., as shown in FIG. 19) or extended position (e.g., as shown in FIGS. 20 and 21), opening 210, which may be a door in side 208, which may be a right side of main body 202, may be used for ingress or egress for main body 202.

As is the case with extendable camper 200 and as mentioned, main body 202 may be attached to extension body 214; where main body 202 and extension body 214 may have 1 pair of respective, adjacent sides (e.g., located at or near the front of main body 202), when extension body 214 is in a retracted position, as shown in FIG. 19. Additionally, portions of the frame of main body 202, if present, such as the tongue in the front, which may extend beyond the front side of main body 202, may also be adjacent to portions of extension body 214. With extension body 214 extended away from main body 202, as shown in FIGS. 20 and 21, features in or on the pair of adjacent sides of main body 202 and extension body 214 (e.g., features on the adjacent sides of main body 202 and extension body 214 that abut or face each other in a retracted position, as shown in FIG. 19, where those features may be blocked or inaccessible in that position), as mentioned previously, or portions of the frame of main body 202 that extend beyond the sides of main body 202 and are adjacent to portions of extension body 214 (e.g., when in a retracted position) may now be accessible.

With extension body 214 in a retracted position, adjacent to main body 202, extendable camper 200 may have a smaller footprint (e.g., reduced length and/or width), which may be preferrable or necessary for transportation and/or storage. Additionally, the surface of side 216 of extension body 214 that abuts or faces side 204 of main body 202 (e.g., when retracted), may have a greater surface area, be flatter, or have other beneficial features for use when compared with the outward-facing surfaces of the same side, allowing for a larger opening on that surface (e.g., to compartment 218), or a flatter, or more beneficial interior surface for use (e.g., when extended); while the outward-facing surface (e.g., outward-facing surface of side 216 that does not abut or face side 204 of main body 202) may have a surface with certain shapes and/or other features that are beneficial for transportation (e.g., when retracted) such as: an outward-facing surface of front side 216 being angled inward, toward the front, for better aerodynamics and/or containing other features for improved aerodynamics or performance while extendable camper 200 is in transit, both on and off road.

With extension body 214 extended away from main body 202 of extendable camper 200, a side of extension body 214, individually; or together with one or more sides of main body 202, which may be the one or more sides of main body 202 that were adjacent to the side of extension body 214, when in a retracted position, or may be different sides of main body 202, may form one or more additional full or partial enclosures of extendable camper 200. For example, the following pair of sides, which may be adjacent to each other when extension body 214 is in a retracted position, as shown in FIG. 19: side 204 of main body 202 and side 216 of extension body 214; may, when extension body 214 is in an extended position, form a full or partial enclosure to the right side of extendable camper 200, as shown in FIGS. 20 and 21, comprised of: side 208 of main body 202, and side 216 of extension body 214. With extendable camper 200 having an additional full or partial enclosure when extended, as shown in FIGS. 20 and 21, the following side features may be more fully or partially sheltered and accessed from within the additional enclosure: opening 210 in side 208 of main body 202, and compartment 218 in side 216 of extension body 214.

Extendable camper 200 may be extended or retracted manually, by powered means, or by a combination of manual and powered means. Extension body 214 that may be extendably connected to main body 202 may be extended or retracted by: powered means with actuators or motors; manually-assisted means with gas springs or struts, or with other types of springs or aids; or manual means, with a person pulling, pushing, or moving extension body 214. The slides connecting extension body 214 to main body 202 may contain locks and/or latches and/or other parts of extension body 214, and/or main body 202 may contain locks and/or latches to secure extension body 214 at certain positions (e.g., a retracted position, an extended position, or positions between a fully retracted and fully extended position), until and unless the locks and/or latches are unlocked and/or unlatched, respectively.

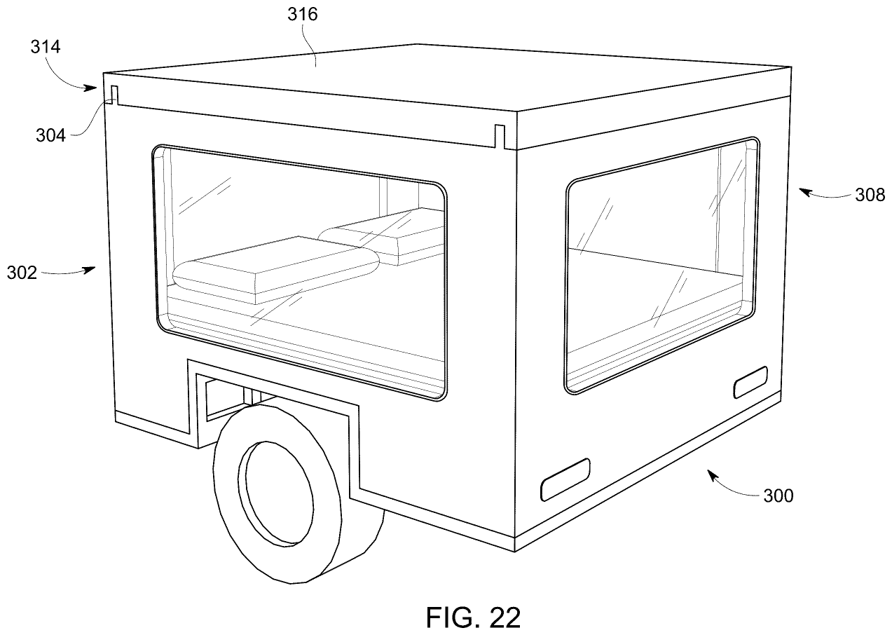

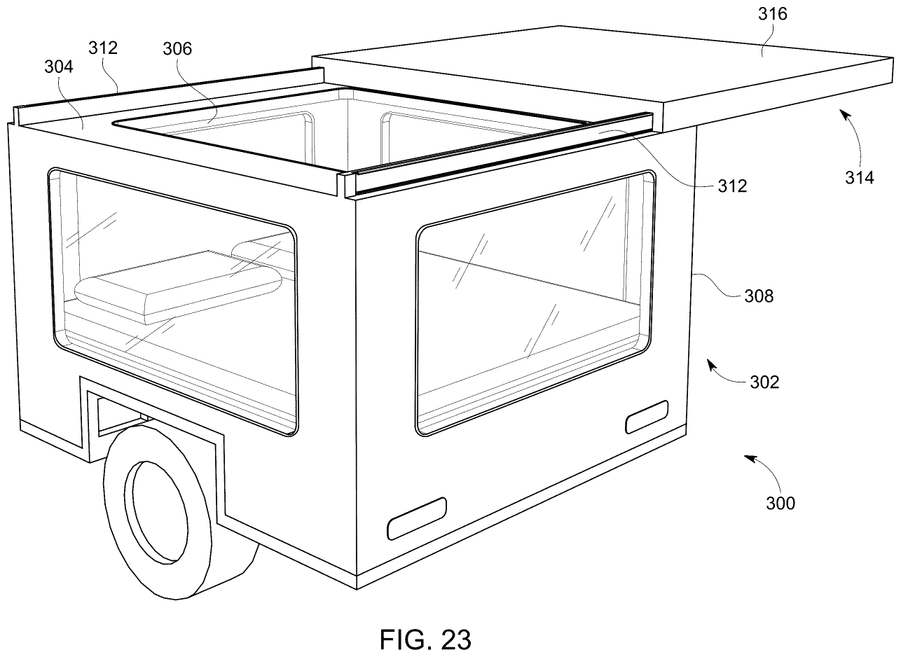

Extendable camper 300 and components thereof are shown in FIGS. 22-25. Extendable camper 300 may be comprised of main body 302, which may be a hard-sided camper body (e.g., as shown in FIGS. 22-25); and extension body 314, which may be a hard-sided extension body configured to move between a retracted position, where it is adjacent to main body 302 (e.g., as shown in FIG. 22), and an extended position, where it is extended away from main body 302 (e.g., as shown in FIGS. 23-25); where main body 302 and extension body 314 may each form an independent enclosure in both retracted and extended positions (e.g., are each independently sealed or do not require sealing); where main body 302 is not dependent on extension body 314 to form a self-contained camper (e.g., main body 302 can function as a camper with or without extension body 314); and where side features (e.g., features in or on the sides of main body 302 and extension body 314) such as opening 306 in side 304 of main body 302, and compartment 318 and straps 324 in side 316 of extension body 314, and other openings, compartments, storage cabinets, kitchen fixtures, bathroom fixtures, utility fixtures, or other features or components that may be located in or on the sides of both main body 302 and extension body 314 that are adjacent to each other (e.g., in a retracted position, and may be blocked and inaccessible in that position, as shown in FIG. 22) may be accessible in an extended position, as shown in FIGS. 23-25.

Extendable camper 300 may contain main body 302, which may be a hard-sided body that is self-contained and comprised of a frame; an interior living space; wheels and a chassis; a trailer tongue with a hitch coupler, jack, and/or other trailer components; and/or other components, as shown in FIGS. 22-25. Main body 302 may be fully sealed (e.g., from water and/or insects), forming an independent enclosure that is not dependent on extension body 314. Main body 302 may contain in and/or on its sides (e.g., front, rear, left, right, and/or top sides) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures.

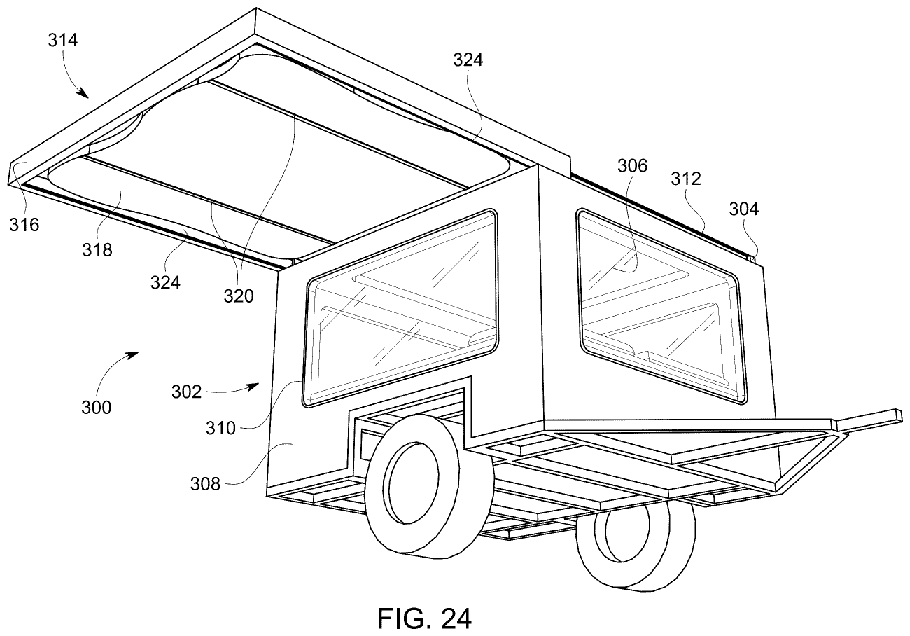

As shown in FIGS. 23 and 24, main body 302 may contain: opening 306, which may be window in side 304, which may be a roof; and opening 310, which may be a door in side 308, which may be a right side. Main body 302 may contain a portion of one or more sliding mechanisms such as a fixed portion of one or more heavy-duty slides, where a sliding portion is inserted into the fixed portion, allowing the sliding portion to slide back and forth inside the fixed portion, further into or further out of the fixed portion, causing retraction or extension, respectively, of the slides. As shown in FIGS. 23-25, main body 302 may contain two fixed members 312 on side 304, which may be the fixed portions of two heavy duty slides that contain the corresponding sliding portions on extension body 314 on side 316, slidably connecting extension body 314 to main body 302, as shown extended in FIGS. 23-25. If side 304 of main body 302 is mostly horizontal or flat (e.g., if side 304 is a top side or roof) and if it would be beneficial for fixed members 312 to be attached to a vertical surface (e.g., if the heavy-duty slides are designed for vertical mounting), side 304 may contain vertical protrusions, which may be continuous portions of side 304, as shown in FIGS. 22 and 23, or may be vertical brackets fixed to side 304, to which fixed members 312 may be attached.

Main body 302 of extendable camper 300 may be configured such that extension body 314, which may be an extension body configured as a hard-sided body, may be slidably attached to or adjacent to at least one of main body 302's external sides. A fixed portion of one or more slides, which may be attached to main body 302, may allow extension body 314, which may contain a corresponding sliding portion of the one or more slides, respectively, to slide away from or toward main body 302. As shown in FIG. 24, extension body 314 may contain two sliding members 324 on side 316, which may be the sliding portions of two heavy duty slides that contain the corresponding fixed portions on main body 302 on side 304, slidably connecting extension body 314 to main body 302. As shown in FIGS. 22 and 23, side 316 of extension body 314 may contain notches, gaps, or spaces to align with and accommodate vertical protrusions, brackets, and/or other components in or on side 304 of main body 302 to which fixed members 312 may be attached (e.g., if side 304 of main body 302 is mostly horizontal or flat and if it would be beneficial for fixed members 312 to be attached to a vertical surface, side 304 may contain vertical protrusions or brackets, as mentioned above).

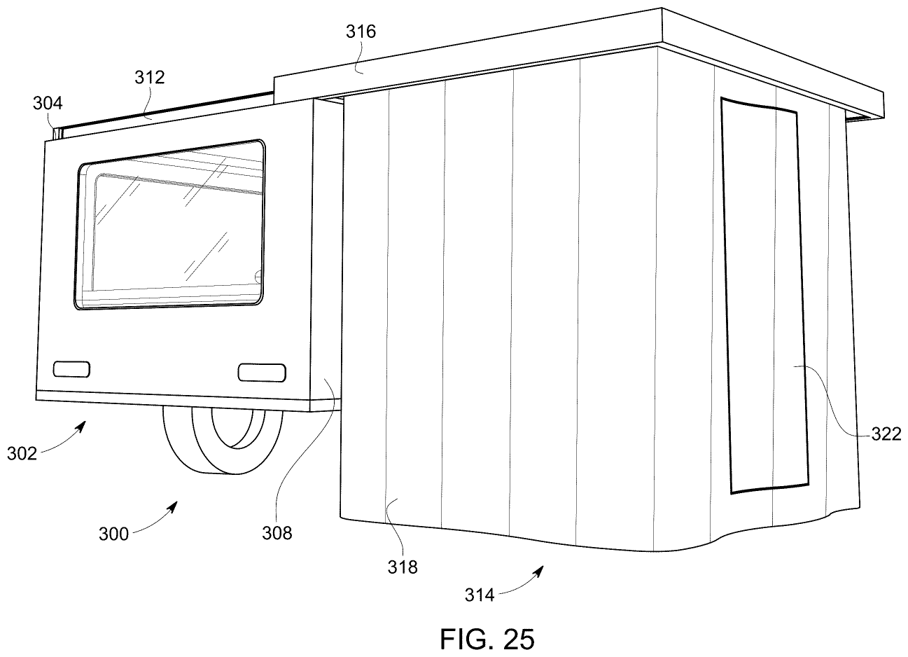

Extension body 314 may be configured to move between a retracted position, where one of its sides is adjacent to one side of main body 302, and an extended position, where it may be extended away from main body 302, such that none of its sides is, or is fully, adjacent to a side of main body 302. Extension body 314 may be extendable by the one or more slides attaching it to main body 302, allowing extension body 314 to slide horizontally toward, as shown fully retracted in FIG. 22, or away, as shown fully extended in FIGS. 23-25, from main body 302. Extension body 314 may be fully sealed, forming an independent enclosure (e.g., may be or may contain one or more compartments, enclosures, or other internal components that is sealed from water and/or insects) or may not require sealing and is not dependent on main body 302. Extension body 314 may contain in or on its sides (e.g., sides that face main body 302, face away from main body 302, or face another direction) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures. Extension body 314 may contain compartment 318, which may be a soft-sided compartment or enclosure, held in a collapsed or stored position by straps 320, as shown in FIG. 24, and may be extended and accessible through opening 322, as shown in FIG. 25, for use as a tent vestibule for changing clothes, using the bathroom, cooking, or for other purposes in side 316, which may be a roof.

When extendable camper 300 is in a retracted position, as shown in FIG. 22, a side of main body 302 may be adjacent to a side of extension body 314, and access to those adjacent sides and/or features (e.g., as mentioned above) on those adjacent sides on each body may be blocked, however, when extendable camper 300 is in an extended position with extension body 314 extended away, as shown in FIGS. 23-25, from main body 302, access to those adjacent sides and/or features on those adjacent sides of main body 302 and extension body 314 may now be gained. When extendable camper 300 is in an extended position, features on adjacent sides of main body 302, and/or extension body 314, which may include openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures may now be used, opened, exposed, extended, connected, and/or accessed. When extendable camper 300 is in an extended position as shown in FIGS. 23-25, opening 306, which may be a window in side 304, which may be a roof of main body 302, may be used to ventilate, or to view into or out of main body 302; and compartment 318, which may be a soft-sided compartment or enclosure in side 316, which may be a roof of extension body 314, may be extended and used as a tent vestibule for changing clothes, using the bathroom, cooking, or for other purposes. Whether extendable camper 300 is in a retracted position (e.g., as shown in FIG. 22) or extended position (e.g., as shown in FIGS. 23-25), opening 310, which may be a door in side 308, which may be a right side of main body 302, may be used for ingress or egress for main body 302.

As is the case with extendable camper 300 and as mentioned, main body 302 may be attached to extension body 314; where main body 302 and extension body 314 may have 1 pair of respective, adjacent sides (e.g., located at or near the roof of main body 302), when extension body 314 is in a retracted position, as shown in FIG. 22. With extension body 314 extended away from main body 302, as shown in FIGS. 23-25, features in or on the pair of adjacent sides of main body 302 and extension body 314 (e.g., features on the adjacent sides of main body 302 and extension body 314 that abut or face each other in a retracted position, as shown in FIG. 22, where those features may be blocked or inaccessible in that position), as mentioned previously, may now be accessible. With extension body 314 in a retracted position, adjacent to main body 302, extendable camper 300 may have a smaller footprint (e.g., reduced length and/or width), which may be preferrable or necessary for transportation and/or storage. Additionally, the surface of side 316 of extension body 314 that abuts or faces side 304 of main body 302 (e.g., when retracted), may have a greater surface area, contain an indentation for storage (e.g., of a soft-sided compartment or enclosure), or have other beneficial features for use when compared with the outward-facing surfaces of the same side, allowing for a larger opening on that surface (e.g., to compartment 318), or more beneficial interior surface for use (e.g., when extended); while the outward-facing surface (e.g., outward-facing surface of side 316 that does not abut or face side 304 of main body 302) may have a surface with certain shapes and/or other features that are beneficial for transportation (e.g., when retracted) such as: an outward-facing surface of top side 316 being flat, and/or ruggedized (e.g., for protection of extendable camper 300 from rocks, tree limbs, and/or brush while traversing tight road or trails) and/or containing other features for improved aerodynamics or performance while extendable camper 300 is in transit, both on and off road.

With extension body 314 extended away from main body 302 of extendable camper 300, a side of extension body 314, individually; or together with one or more sides of main body 302, which may be the one or more sides of main body 302 that were adjacent to the side of extension body 314, when in a retracted position, or may be different sides of main body 302, may form one or more additional full or partial enclosures of extendable camper 300. For example, the following pair of sides, which may be adjacent to each other when extension body 314 is in a retracted position, as shown in FIG. 22: side 304 of main body 302 and side 316 of extension body 314; may, when extension body 314 is in an extended position, form a full or partial enclosure to the right side of extendable camper 300, as shown in FIGS. 23-25, comprised of: side 308 of main body 302, and side 316 of extension body 314. With extendable camper 300 having an additional full or partial enclosure when extended, as shown in FIGS. 23-25, the following side features may be more fully or partially sheltered and accessed from within the additional enclosure: opening 310 in side 308 of main body 302, and compartment 318 in side 316 of extension body 314.

Extendable camper 300 may be extended or retracted manually, by powered means, or by a combination of manual and powered means. Extension body 314 that may be extendably connected to main body 302 may be extended or retracted by: powered means with actuators or motors; manually-assisted means with gas springs or struts, or with other types of springs or aids; or manual means, with a person pulling, pushing, or moving extension body 314. The slides connecting extension body 314 to main body 302 may contain locks and/or latches and/or other parts of extension body 314, and/or main body 302 may contain locks and/or latches to secure extension body 314 at certain positions (e.g., a retracted position, an extended position, or positions between a fully retracted and fully extended position), until and unless the locks and/or latches are unlocked and/or unlatched, respectively.

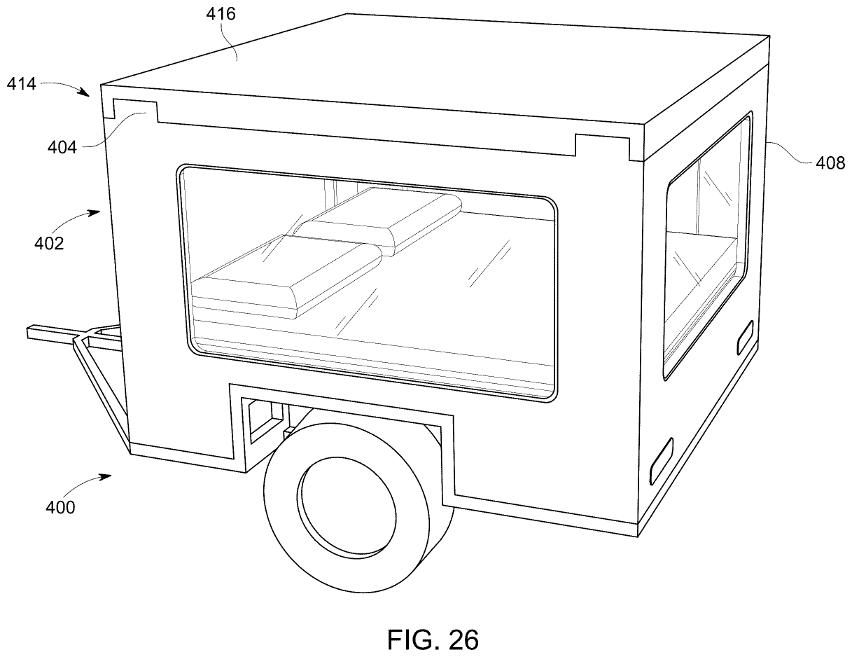

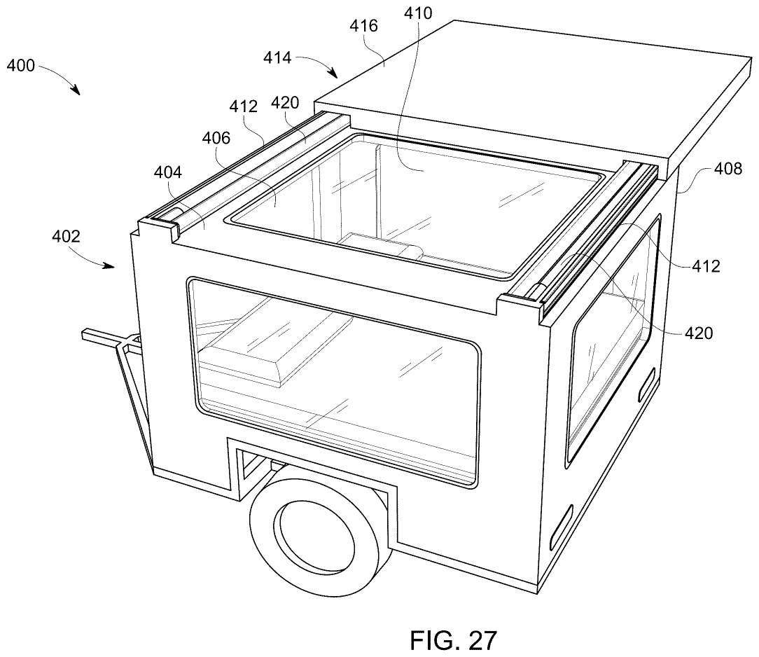

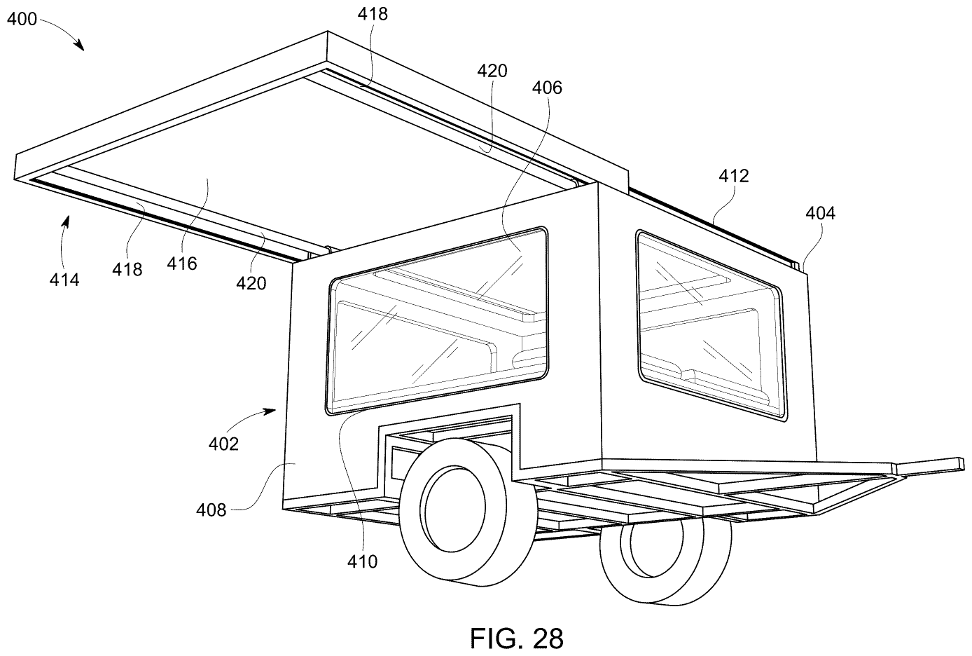

Extendable camper 400 and components thereof are shown in FIGS. 26-28. Extendable camper 400 may be comprised of main body 402, which may be a hard-sided camper body (e.g., as shown in FIGS. 26-28); and extension body 414, which may be a hard-sided extension body configured to move between a retracted position, where it is adjacent to main body 402 (e.g., as shown in FIG. 26), and an extended position, where it is extended away from main body 402 (e.g., as shown in FIGS. 27 and 28); where main body 402 and extension body 414 may each form an independent enclosure in both retracted and extended positions (e.g., are each independently sealed or do not require sealing); where main body 402 is not dependent on extension body 414 to form a self-contained camper (e.g., main body 402 can function as a camper with or without extension body 414); and where side features (e.g., features in or on the sides of main body 402 and extension body 414) such as opening 406 in side 404 of main body 402, and other openings, compartments, storage cabinets, kitchen fixtures, bathroom fixtures, utility fixtures, or other features or components that may be located in or on the sides of both main body 402 and extension body 414 that are adjacent to each other (e.g., in a retracted position, and may be blocked and inaccessible in that position, as shown in FIG. 26) may be accessible in an extended position, as shown in FIGS. 27 and 28.

Extendable camper 400 may contain main body 402, which may be a hard-sided body that is self-contained and comprised of a frame; an interior living space; wheels and a chassis; a trailer tongue with a hitch coupler, jack, and/or other trailer components; and/or other components, as shown in FIGS. 26-28. Main body 402 may be fully sealed (e.g., from water and/or insects), forming an independent enclosure that is not dependent on extension body 414. Main body 402 may contain in and/or on its sides (e.g., front, rear, left, right, and/or top sides) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures.

As shown in FIGS. 27 and 28, main body 402 may contain: opening 406, which may be window in side 404, which may be a roof; and opening 410, which may be a door in side 408, which may be a right side. Main body 402 may contain a portion of one or more sliding mechanisms such as a fixed portion of one or more heavy-duty slides, where a sliding portion is inserted into the fixed portion, allowing the sliding portion to slide back and forth inside the fixed portion, further into or further out of the fixed portion, causing retraction or extension, respectively, of the slides. As shown in FIGS. 27 and 28, main body 402 may contain two fixed members 412 on side 404, which may be the fixed portions of two heavy duty slides that contain the corresponding sliding portions on extension body 414 on side 416, slidably connecting extension body 414 to main body 402, as shown extended in FIGS. 27 and 28. If side 404 of main body 402 is mostly horizontal or flat (e.g., if side 404 is a top side or roof) and if it would be beneficial for fixed members 412 to be attached to a vertical surface (e.g., if the heavy-duty slides are designed for vertical mounting), side 404 may contain vertical protrusions, which may be continuous portions of side 404, as shown in FIGS. 27 and 28, or may be vertical brackets fixed to side 404, to which fixed members 412 may be attached.

Main body 402 of extendable camper 400 may be configured such that extension body 414, which may be an extension body configured as a hard-sided body, may be slidably attached to or adjacent to at least one of main body 402's external sides. A fixed portion of one or more slides, which may be attached to main body 402, may allow extension body 414, which may contain a corresponding sliding portion of the one or more slides, respectively, to slide away from or toward main body 402. As shown in FIG. 28, extension body 414 may contain two sliding members 418 on side 416, which may be the sliding portions of two heavy duty slides that contain the corresponding fixed portions on main body 402 on side 404, slidably connecting extension body 414 to main body 402.

As shown in FIGS. 26 and 27, side 416 of extension body 414 may contain notches, gaps, or spaces to align with and accommodate vertical protrusions, brackets, and/or other components in or on side 404 of main body 402 to which fixed members 412 may be attached (e.g., if side 404 of main body 402 is mostly horizontal or flat and if it would be beneficial for fixed members 412 to be attached to a vertical surface, side 404 may contain vertical protrusions or brackets, as mentioned above). Extension body 414 may be configured to move between a retracted position, where one of its sides is adjacent to one side of main body 402, and an extended position, where it may be extended away from main body 402, such that none of its sides is, or is fully, adjacent to a side of main body 402. Extension body 414 may be extendable by the one or more slides attaching it to main body 402, allowing extension body 414 to slide horizontally toward, as shown fully retracted in FIG. 26, or away, as shown fully extended in FIGS. 27 and 28, from main body 402. Extension body 414 may be fully sealed, forming an independent enclosure (e.g., may be or may contain one or more compartments, enclosures, or other internal components that is sealed from water and/or insects) or may not require sealing and is not dependent on main body 402. Extension body 414 may contain in or on its sides (e.g., sides that face main body 402, face away from main body 402, or face another direction) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures.

When extendable camper 400 is in a retracted position, as shown in FIG. 26, a side of main body 402 may be adjacent to a side of extension body 414, and access to those adjacent sides and/or features (e.g., as mentioned above) on those adjacent sides on each body may be blocked, however, when extendable camper 400 is in an extended position with extension body 414 extended away, as shown in FIGS. 26 and 27, from main body 402, access to those adjacent sides and/or features on those adjacent sides of main body 402 and extension body 414 may now be gained. When extendable camper 400 is in an extended position, features on adjacent sides of main body 402, and/or extension body 414, which may include openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures may now be used, opened, exposed, extended, connected, and/or accessed. When extendable camper 400 is in an extended position as shown in FIGS. 27 and 28, opening 406, which may be a window in side 404, which may be a roof of main body 402, may be used to ventilate, or to view into or out of main body 402. Whether extendable camper 400 is in a retracted position (e.g., as shown in FIG. 26) or extended position (e.g., as shown in FIGS. 27 and 28), opening 410, which may be a door in side 408, which may be a right side of main body 402, may be used for ingress or egress for main body 402.

As is the case with extendable camper 400 and as mentioned, main body 402 may be attached to extension body 414; where main body 402 and extension body 414 may have 1 pair of respective, adjacent sides (e.g., located at or near the roof of main body 402), when extension body 414 is in a retracted position, as shown in FIG. 26. With extension body 414 extended away from main body 402, as shown in FIGS. 27 and 28, features in or on the pair of adjacent sides of main body 402 and extension body 414 (e.g., features on the adjacent sides of main body 402 and extension body 414 that abut or face each other in a retracted position, as shown in FIG. 26, where those features may be blocked or inaccessible in that position), as mentioned previously, may now be accessible. With extension body 414 in a retracted position, adjacent to main body 402, extendable camper 400 may have a smaller footprint (e.g., reduced length and/or width), which may be preferrable or necessary for transportation and/or storage. Additionally, the surface of side 416 of extension body 414 that abuts or faces side 404 of main body 402 (e.g., when retracted), may have a greater surface area, contain an indentation for improved functionality as an awning (e.g., have small vertical, dropped sides that better protect against falling rain), or have other beneficial features for use when compared with the outward-facing surfaces of the same side; while the outward-facing surface (e.g., outward-facing surface of side 416 that does not abut or face side 404 of main body 402) may have a surface with certain shapes and/or other features that are beneficial for transportation (e.g., when retracted) such as: an outward-facing surface of top side 416 being flat, and/or ruggedized (e.g., for protection of extendable camper 400 from rocks, tree limbs, and/or brush while traversing tight road or trails) and/or containing other features for improved aerodynamics or performance while extendable camper 400 is in transit, both on and off road.

With extension body 414 extended away from main body 402 of extendable camper 400, a side of extension body 414, individually; or together with one or more sides of main body 402, which may be the one or more sides of main body 402 that were adjacent to the side of extension body 414, when in a retracted position, or may be different sides of main body 402, may form one or more additional full or partial enclosures of extendable camper 400. For example, the following pair of sides, which may be adjacent to each other when extension body 414 is in a retracted position, as shown in FIG. 26: side 404 of main body 402 and side 416 of extension body 414; may, when extension body 414 is in an extended position, form a full or partial enclosure to the right side of extendable camper 400, as shown in FIGS. 27 and 28, comprised of: side 408 of main body 402, and side 416 of extension body 414. With extendable camper 400 having an additional full or partial enclosure when extended, as shown in FIGS. 27 and 28, the following side features may be more fully or partially sheltered and accessed from within the additional enclosure: opening 410 in side 408 of main body 402.

Extendable camper 400 may be extended or retracted manually, by powered means, or by a combination of manual and powered means. Extension body 414 that may be extendably connected to main body 402 may be extended or retracted by: powered means with actuators or motors; manually-assisted means with gas springs or struts, or with other types of springs or aids; or manual means, with a person pulling, pushing, or moving extension body 414. As shown in FIGS. 27 and 28, extendable camper 400 may contain two of actuators 420, where a portion or end of each is attached to side 404 in main body 402 and another portion or the other end of each is attached to side 416 of extension body 414. Actuators 420 may be powered, electronic actuators capable of extending or retracting the heavy duty slides comprised of two of fixed members 412 on side 404 of main body 402 and two of sliding members 418 on side 416 of extension body 414, thereby extending or retracting, respectively, extension body 414 away or toward, respectively, main body 402. Actuators 420 may be controlled by a switch or button located inside or outside main body 402, or located on a remote control, allowing extension body 414 to be conveniently extended or retracted from inside or outside, respectively, extendable camper 400, or from anywhere within range of the remote. Actuators 420 may also be extended or retracted by a switch controllable by a timer or light sensor, which can be programmed or cause to extend or retract, respectively, extension body 414 at a specific time, or as the sun rises or sets, respectively.

Automatic extension or retraction of extension body 414 may be particularly beneficial for allowing campers to fall asleep inside main body 402 while having a view of the night sky through opening 406 in side 404, when extension body 414 is extended, as shown in FIGS. 27 and 28; then being automatically shaded from the morning sun by a timer set to retract extension body 414 before sunrise, or by a light sensor causing extension body 414 to retract as the run begins to rise, so that side 416 covers (e.g., shades) opening 406 in side 404, as shown in FIG. 26. The slides connecting extension body 414 to main body 402 may contain locks and/or latches and/or other parts of extension body 414, and/or main body 402 may contain locks and/or latches to secure extension body 414 at certain positions (e.g., a retracted position, an extended position, or positions between a fully retracted and fully extended position), until and unless the locks and/or latches are unlocked and/or unlatched, respectively. Alternatively, actuators 420 may alone be enough to keep extension body 414 in a desired position until and unless actuators 420 are caused to extend or retract.

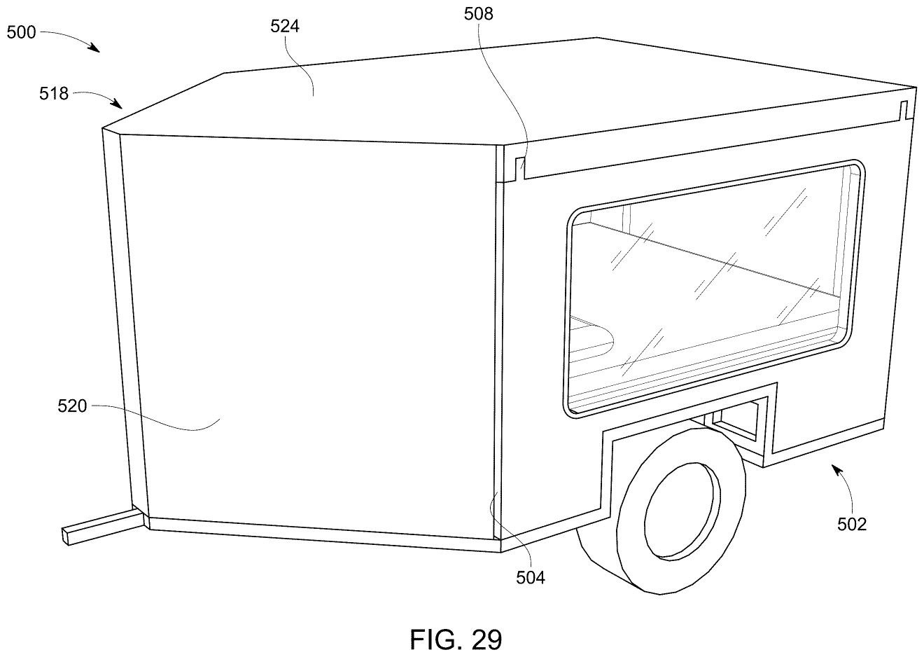

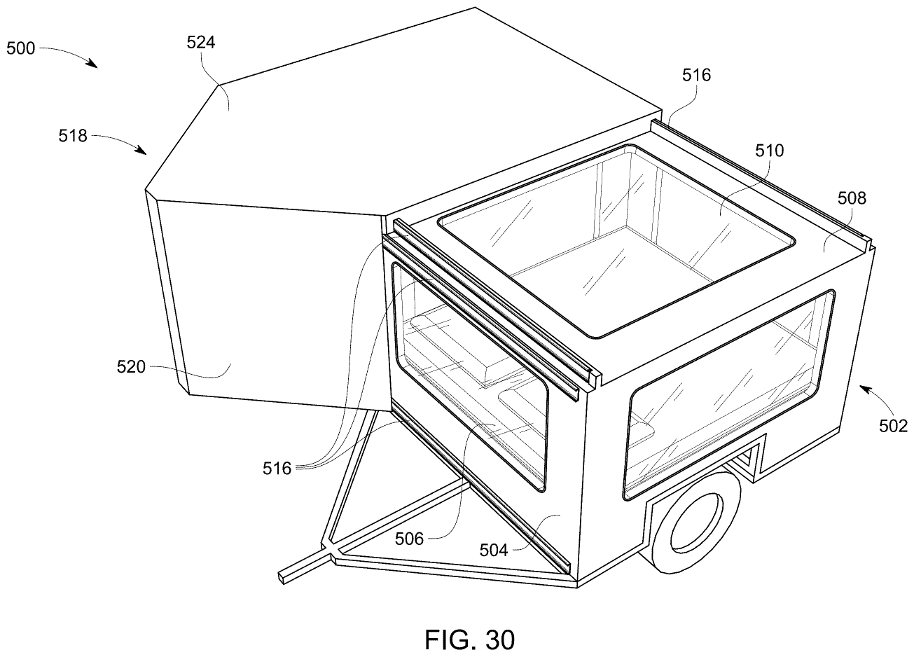

Extendable camper 500 and components thereof are shown in FIGS. 29-32. Extendable camper 500 may be comprised of main body 502, which may be a hard-sided camper body (e.g., as shown in FIGS. 29-32); and extension body 518, which may be a hard-sided extension body configured to move between a retracted position, where it is adjacent to main body 502 (e.g., as shown in FIG. 29), and an extended position, where it is extended away from main body 502 (e.g., as shown in FIGS. 30-32); where main body 502 and extension body 518 may each form an independent enclosure in both retracted and extended positions (e.g., are each independently sealed or do not require sealing); where main body 502 is not dependent on extension body 518 to form a self-contained camper (e.g., main body 502 can function as a camper with or without extension body 518); and where side features (e.g., features in or on the sides of main body 502 and extension body 518) such as opening 506 in side 504 of main body 502, opening 510 in side 508 of main body 502, compartment 522 in side 520 of extension body 518, and compartment 526 in side 524 of extension body 518, and other openings, compartments, storage cabinets, kitchen fixtures, bathroom fixtures, utility fixtures, or other features or components that may be located in or on the sides of both main body 502 and extension body 518 that are adjacent to each other (e.g., in a retracted position, and may be blocked and inaccessible in that position, as shown in FIG. 29) may be accessible in an extended position, as shown in FIGS. 30-32.

Extendable camper 500 may contain main body 502, which may be a hard-sided body that is self-contained and comprised of a frame; an interior living space; wheels and a chassis; a trailer tongue with a hitch coupler, jack, and/or other trailer components; and/or other components, as shown in FIGS. 29-32. Main body 502 may be fully sealed (e.g., from water and/or insects), forming an independent enclosure that is not dependent on extension body 518. Main body 502 may contain in and/or on its sides (e.g., front, rear, left, right, and/or top sides) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures.

As shown in FIGS. 30-32, main body 502 may contain: opening 506, which may be a window in side 504, which may be a front side; opening 510, which may be window in side 508, which may be a roof; and opening 514, which may be a door in side 512, which may be a right side. Main body 502 may contain a portion of one or more sliding mechanisms such as a fixed portion of one or more heavy-duty slides, where a sliding portion is inserted into the fixed portion, allowing the sliding portion to slide back and forth inside the fixed portion, further into or further out of the fixed portion, causing retraction or extension, respectively, of the slides. As shown in FIGS. 30-32, main body 502 may contain four fixed members 516, with two on side 504 and two on side 508, which may be the fixed portions of four heavy duty slides that contain the corresponding sliding portions on extension body 518, with two on side 520 and two on side 524, respectively, slidably connecting extension body 518 to main body 502, as shown extended in FIGS. 30-32. If side 508 of main body 502 is mostly horizontal or flat (e.g., if side 508 is a top side or roof) and if it would be beneficial for fixed members 516 to be attached to a vertical surface (e.g., if the heavy-duty slides are designed for vertical mounting), side 508 may contain vertical protrusions, which may be continuous portions of side 508, as shown in FIGS. 29 and 30, or may be vertical brackets fixed to side 508, to which two of fixed members 516 may be attached.

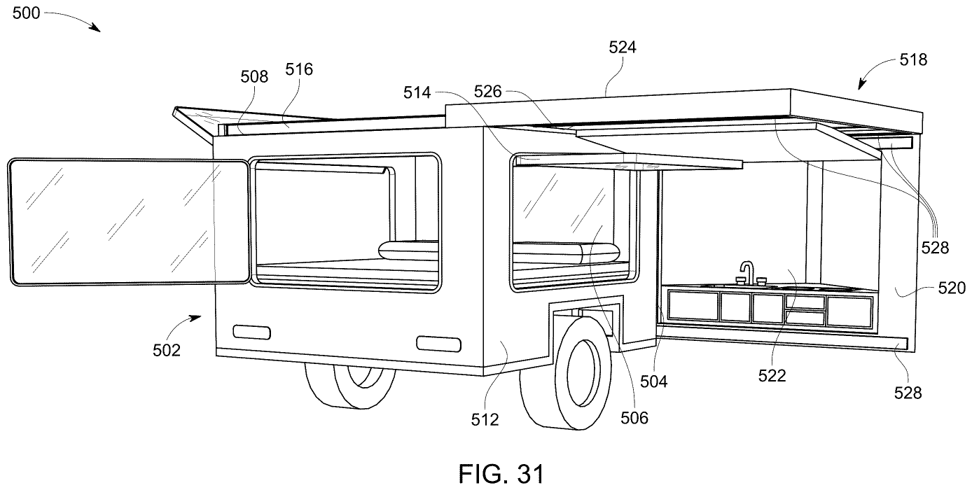

Main body 502 of extendable camper 500 may be configured such that extension body 518, which may be an extension body configured as a hard-sided body, may be slidably attached to or adjacent to at least one of main body 502's external sides. A fixed portion of one or more slides, which may be attached to main body 502, may allow extension body 518, which may contain a corresponding sliding portion of the one or more slides, respectively, to slide away from or toward main body 502. As shown in FIG. 31, extension body 518 may contain four sliding members 528, with two on side 520 and two on side 524, which may be the sliding portions of four heavy duty slides that contain the corresponding fixed portions on main body 502, with two on side 504 and two on side 508, respectively, slidably connecting extension body 518 to main body 502.

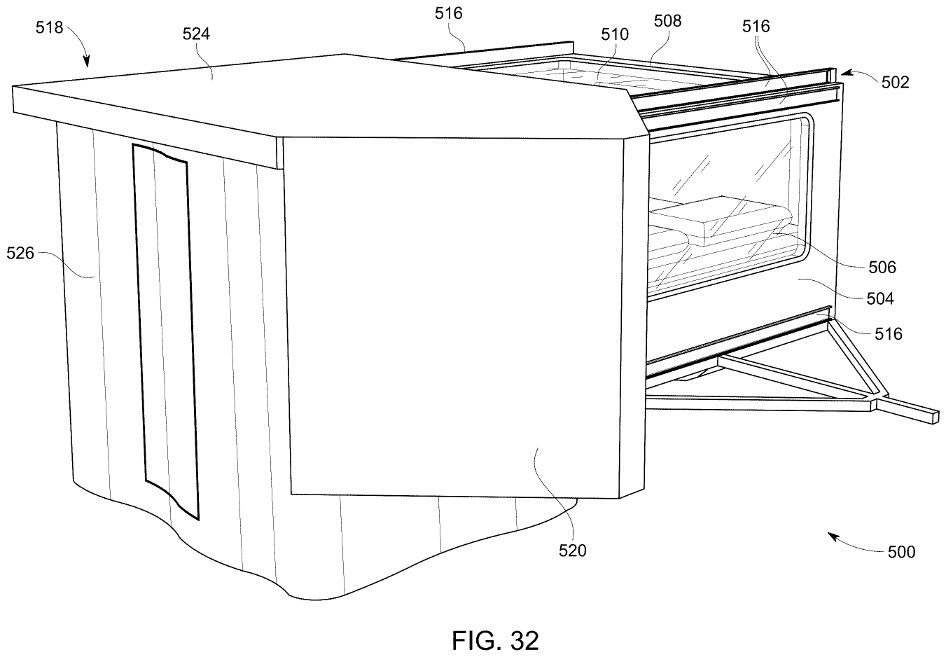

As shown in FIGS. 29 and 30, side 524 of extension body 518 may contain notches, gaps, or spaces to align with and accommodate vertical protrusions, brackets, and/or other components in or on side 508 of main body 502 to which two of fixed members 516 may be attached (e.g., if side 508 of main body 502 is mostly horizontal or flat and if it would be beneficial for fixed members 516 to be attached to a vertical surface, side 508 may contain vertical protrusions or brackets, as mentioned above). Extension body 518 may be configured to move between a retracted position, where one or more of its sides is adjacent to one or more sides, respectively, of main body 502, and an extended position, where it may be extended away from main body 502, such that the one or more of its sides is not, or is not fully, adjacent to the one or more sides, respectively, of main body 502. Extension body 518 may be extendable by the one or more slides attaching it to main body 502, allowing extension body 518 to slide horizontally toward, as shown fully retracted in FIG. 29, or away, as shown fully extended in FIGS. 30-32, from main body 502. Extension body 518 may be fully sealed, forming an independent enclosure (e.g., may be or may contain one or more compartments, enclosures, or other internal components that is sealed from water and/or insects) or may not require sealing and is not dependent on main body 502. Extension body 518 may contain in or on its sides (e.g., sides that face main body 502, face away from main body 502, or face another direction) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures. Extension body 518 may contain: compartment 522, which may be a compartment containing kitchen fixtures in side 520, which may be a front side, as shown in FIG. 31; and compartment 526, which may be a soft-sided compartment or enclosure, held in a collapsed or stored position, as shown in FIG. 31, and may be extended, as shown in FIG. 32, for use as a tent vestibule for changing clothes, using the bathroom, cooking, or for other purposes in side 524, which may be a roof.

When extendable camper 500 is in a retracted position, as shown in FIG. 29, one or more sides of main body 502 may be adjacent to one or more sides of extension body 518, and access to those adjacent sides and/or features (e.g., as mentioned above) on those adjacent sides on each body may be blocked, however, when extendable camper 500 is in an extended position with extension body 518 extended away, as shown in FIGS. 30-32, from main body 502, access to those adjacent sides and/or features on those adjacent sides of main body 502 and extension body 518 may now be gained. When extendable camper 500 is in an extended position, features on adjacent sides of main body 502, and/or extension body 518, which may include openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures may now be used, opened, exposed, extended, connected, and/or accessed. When extendable camper 500 is in an extended position as shown in FIGS. 30-32, opening 506, which may be a window in side 504, which may be a front side of main body 502, may be used to ventilate, or to view into or out of main body 502; opening 510, which may be a window in side 508, which may be a roof of main body 502, may be used to ventilate, or to view into or out of main body 502; compartment 522, which may be a compartment containing kitchen fixtures in side 520, which may be a front side of extension body 518, may be opened and used as a kitchen or closed to keep food and/or other kitchen items in a sealed enclosure; and compartment 526, which may be a soft-sided compartment or enclosure in side 524, which may be a roof of extension body 518, may be extended and used as a tent vestibule for changing clothes, using the bathroom, cooking, or for other purposes. Whether extendable camper 500 is in a retracted position (e.g., as shown in FIG. 29) or extended position (e.g., as shown in FIGS. 30-32), opening 514, which may be a door in side 512, which may be a right side of main body 502, may be used for ingress or egress for main body 502.

As is the case with extendable camper 500 and as mentioned, main body 502 may be attached to extension body 518; where main body 502 and extension body 518 may have 2 pairs of respective, adjacent sides (e.g., located at or near the front and roof of main body 502), when extension body 518 is in a retracted position, as shown in FIG. 29. Additionally, portions of the frame of main body 502, if present, such as the tongue in the front, which may extend beyond the front side of main body 502, may also be adjacent to portions of extension body 518. With extension body 518 extended away from main body 502, as shown in FIGS. 30-32, features in or on the pairs of adjacent sides of main body 502 and extension body 518 (e.g., features on the adjacent sides of main body 502 and extension body 518 that abut or face each other in a retracted position, as shown in FIG. 29, where those features may be blocked or inaccessible in that position), as mentioned previously, or portions of the frame of main body 502 that extend beyond the sides of main body 502 and are adjacent to portions of extension body 518 (e.g., when in a retracted position) may now be accessible. With extension body 518 in a retracted position, adjacent to main body 502, extendable camper 500 may have a smaller footprint (e.g., reduced length and/or width), which may be preferrable or necessary for transportation and/or storage. Additionally, the surfaces of sides 520 and 524 of extension body 518 that abut or face sides 504 and 508, respectively, of main body 502 (e.g., when retracted), may have a greater surface area, be flatter, contain an indentation for storage (e.g., of a soft-sided compartment or enclosure), or have other beneficial features for use when compared with the outward-facing surfaces of the same sides, allowing for a larger opening on those surfaces (e.g., to compartment 522), or flatter, or more beneficial interior surfaces for use (e.g., when extended); while the outward-facing surfaces (e.g., outward-facing surfaces of sides 520 and 524 that do not abut or face sides 504 and 508, respectively, of main body 502) may have surfaces with certain shapes and/or other features that are beneficial for transportation (e.g., when retracted) such as: an outward-facing surface of front side 520 being angled inward, toward the front, for better aerodynamics; an outward-facing surface of top side 524 being flat, and/or ruggedized (e.g., for protection of extendable camper 500 from rocks, tree limbs, and/or brush while traversing tight road or trails), and/or containing other features for improved aerodynamics or performance while extendable camper 500 is in transit, both on and off road.

With extension body 518 extended away from main body 502 of extendable camper 500, one or more sides of extension body 518, individually; together with one or more other sides of extension body 518; or together with one or more sides of main body 502, which may be the one or more sides of main body 502 that were adjacent to the one or more respective sides of extension body 518, when in a retracted position, or may be different sides of main body 502, may form one or more additional full or partial enclosures of extendable camper 500. For example, the following pairs of sides, which may be adjacent to each other when extension body 518 is in a retracted position, as shown in FIG. 29: side 504 of main body 502 and side 520 of extension body 518; and side 508 of main body 502 and side 524 of extension body 518 may, when extension body 518 is in an extended position, form a full or partial enclosure to the right side of extendable camper 500, as shown in FIGS. 30-32, comprised of: side 512 of main body 502, and sides 520 and 524 of extension body 518. With extendable camper 500 having an additional full or partial enclosure when extended, as shown in FIGS. 30-32, the following side features may be more fully or partially sheltered and accessed from within the additional enclosure: opening 514 in side 512 of main body 502, compartment 522 in side 520 of extension body 518, and compartment 526 in side 524 of extension body 518.

Extendable camper 500 may be extended or retracted manually, by powered means, or by a combination of manual and powered means. Extension body 518 that may be extendably connected to main body 502 may be extended or retracted by: powered means with actuators or motors; manually-assisted means with gas springs or struts, or with other types of springs or aids; or manual means, with a person pulling, pushing, or moving extension body 518. The slides connecting extension body 518 to main body 502 may contain locks and/or latches and/or other parts of extension body 518, and/or main body 502 may contain locks and/or latches to secure extension body 518 at certain positions (e.g., a retracted position, an extended position, or positions between a fully retracted and fully extended position), until and unless the locks and/or latches are unlocked and/or unlatched, respectively.

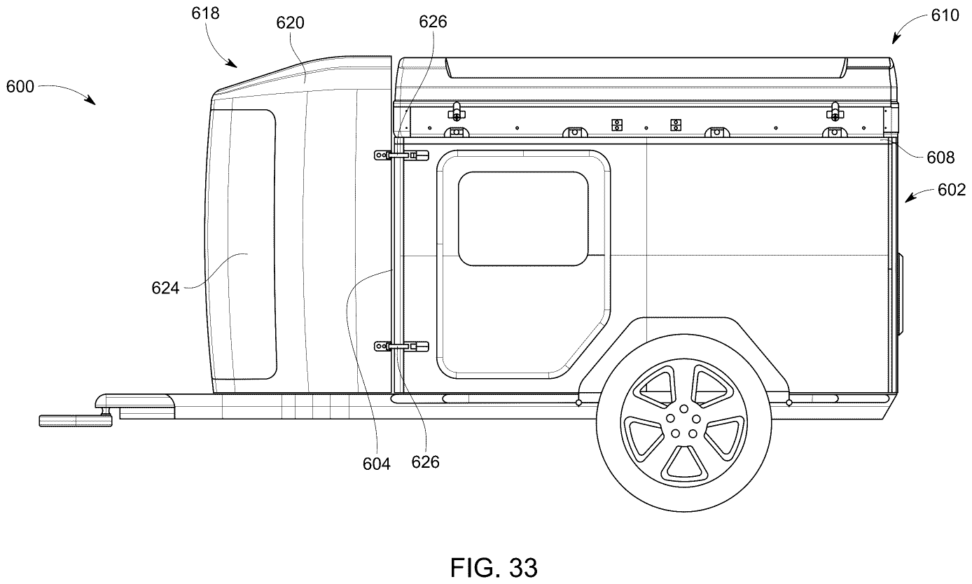

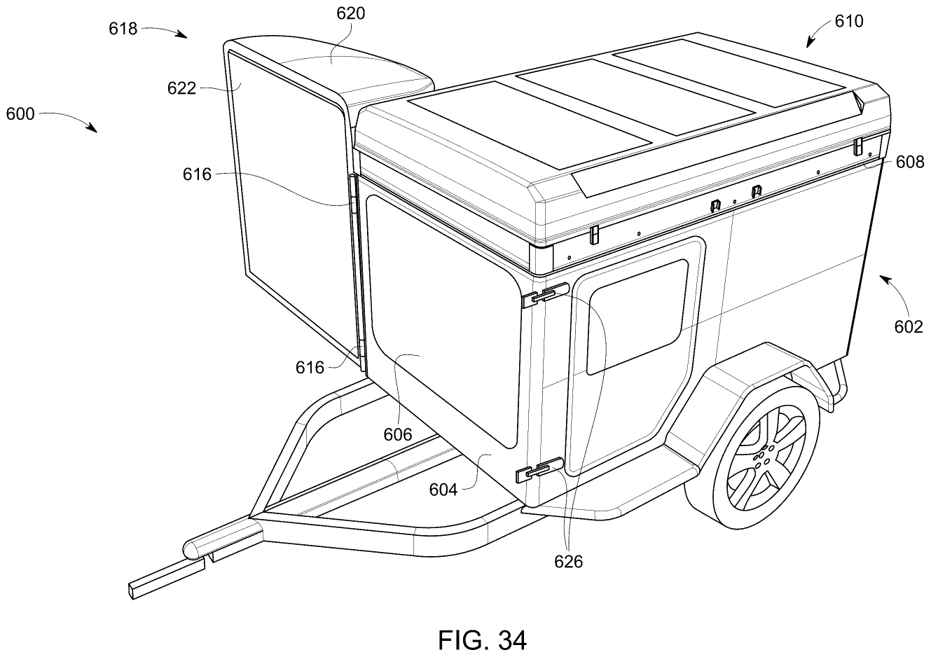

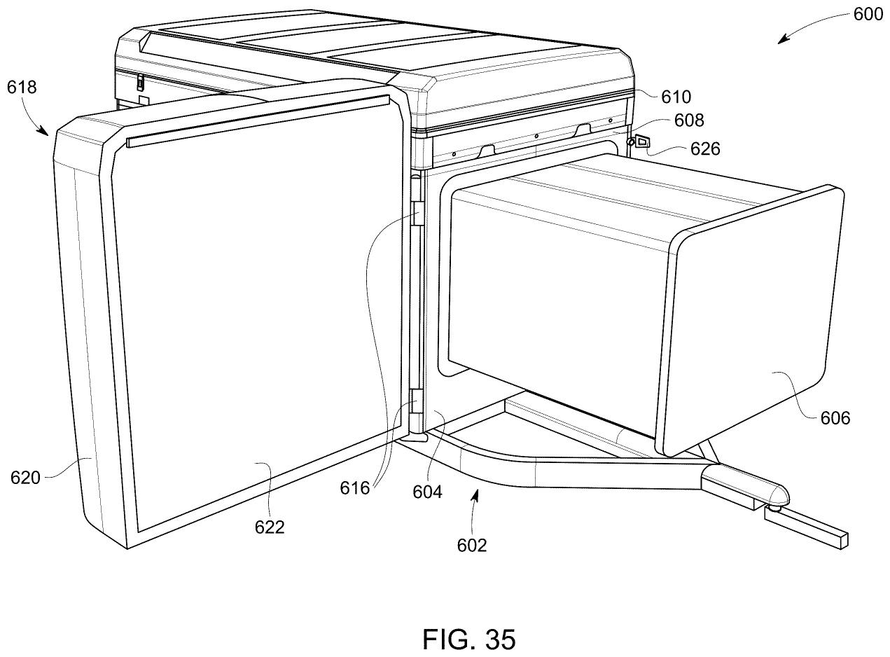

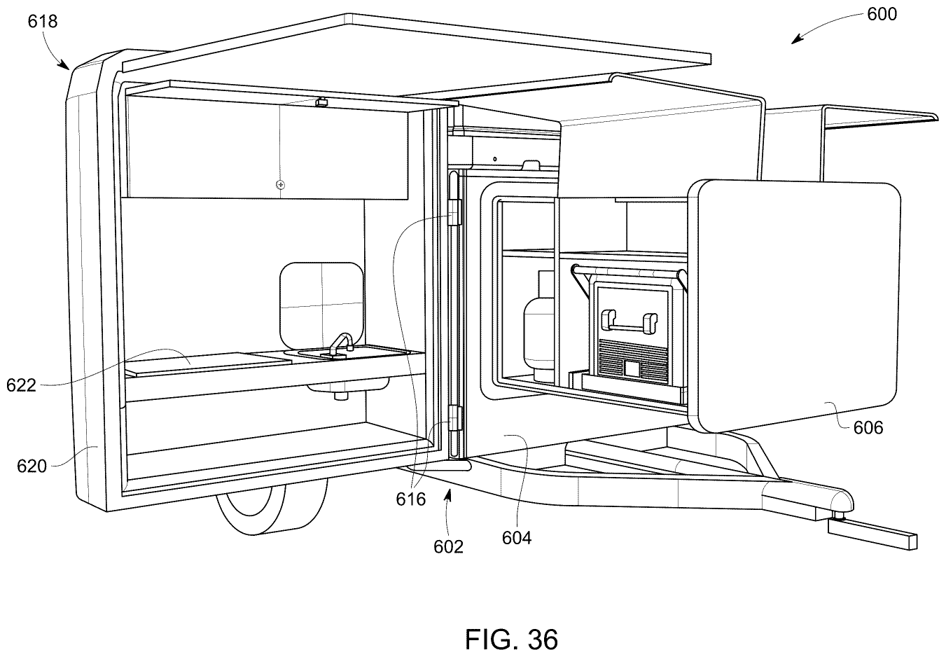

Extendable camper 600 and components thereof are shown in FIGS. 33-37. Extendable camper 600 may be comprised of main body 602, which may be a hard-sided camper body (e.g., as shown in FIGS. 33-37); and extension body 618, which may be a hard-sided extension body configured to move between a retracted position, where it is adjacent to main body 602 (e.g., as shown in FIG. 33), and an extended position, where it is extended away from main body 602 (e.g., as shown in FIGS. 34-37); where main body 602 and extension body 618 may each form an independent enclosure in both retracted and extended positions (e.g., are each independently sealed); where main body 602 is not dependent on extension body 618 to form a self-contained camper (e.g., main body 602 can function as a camper with or without extension body 618); and where side features (e.g., features in or on the sides of main body 602 and extension body 618) such as slide-out 606 in side 604 of main body 602, and compartment 622 in side 620 of extension body 618, and other openings, compartments, storage cabinets, kitchen fixtures, bathroom fixtures, utility fixtures, or other features or components that may be located in or on the sides of both main body 602 and extension body 618 that are adjacent to each other (e.g., in a retracted position, and may be blocked and inaccessible in that position, as shown in FIG. 33) may be accessible in an extended position, as shown in FIGS. 34-37.

Extendable camper 600 may contain main body 602, which may be a hard-sided body that is self-contained and comprised of a frame; an interior living space; wheels and a chassis; a trailer tongue with a hitch coupler, jack, and/or other trailer components; and/or other components, as shown in FIGS. 33-37. Main body 602 may be fully sealed (e.g., from water and/or insects), forming an independent enclosure that is not dependent on extension body 618. Main body 602 may contain in and/or on its sides (e.g., front, rear, left, right, and/or top sides) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures.

As shown in FIGS. 33-37, main body 602 may contain: slide-out 606, which may be a slide-out compartment in side 604, which may be a front side; compartment 610, which may be a collapsible shelter on side 608, which may be a roof; and opening 614, which may be a door in side 612, which may be a right side. Main body 602 may contain a portion of one or more hinges, allowing a corresponding portion of the one or more hinges to be pivoted toward or away from main body 602, causing retraction or extension, respectively, of the hinges. As shown in FIG. 34-36, main body 602 may contain a portion of two hinges 616 on side 604, with corresponding portions of the two hinges on extension body 618 on side 620, pivotably connecting extension body 618 to main body 602, as shown extended in FIGS. 34-37.

Main body 602 of extendable camper 600 may be configured such that extension body 618, which may be an extension body configured as a hard-sided body, may be pivotably attached to or adjacent to at least one of main body 602's external sides. A portion of one or more hinges, which may be attached to main body 602, may allow extension body 618, which may contain the corresponding portion of the one or more hinges, respectively, to pivot away from or toward main body 602. As shown in FIGS. 34-36, extension body 618 may contain a portion of two hinges 616 on side 620, with corresponding portions of the two hinges on main body 602 on side 604, pivotably connecting extension body 618 to main body 602. Extension body 618 may be configured to move between a retracted position, where one of its sides is adjacent to one side of main body 602, and an extended position, where it may be extended away from main body 602, such that none of its sides is, or is fully, adjacent to a side of main body 602. Extension body 618 may be extendable by the one or more hinges attaching it to main body 602, allowing extension body 618 to pivot horizontally toward, as shown fully retracted in FIG. 33, or away, as shown fully extended in FIGS. 34-37, from main body 602. Extension body 618 may be fully sealed, forming an independent enclosure (e.g., may be or may contain one or more compartments, enclosures, or other internal components that is sealed from water and/or insects) and is not dependent on main body 602. Extension body 618 may contain in or on its sides (e.g., sides that face main body 602, face away from main body 602, or face another direction) features that may be openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures. As shown in FIGS. 33-37, extension body 618 may contain compartment 622, which may be a compartment containing kitchen fixtures, and compartment 624, which may be a storage compartment, in side 620, which may be a front side.

When extendable camper 600 is in a retracted position, as shown in FIG. 33, a side of main body 602 may be adjacent to a side of extension body 618, and access to those adjacent sides and/or features (e.g., as mentioned above) on those adjacent sides on each body may be blocked, however, when extendable camper 600 is in an extended position with extension body 618 extended away, as shown in FIGS. 34-37, from main body 602, access to those adjacent sides and/or features on those adjacent sides of main body 602 and extension body 618 may now be gained. When extendable camper 600 is in an extended position, features on adjacent sides of main body 602, and/or extension body 618, which may include openings such as doors, fixed and openable windows, hatches, ports, vents, and/or other openings; fixed and/or extendable compartments or enclosures for storage, utilities, kitchen fixtures, bath fixtures, and/or other living fixtures (e.g., beds, seating, tables, etc.); external fixtures such as storage racks, storage brackets or hooks, legs or supports, fold-out tables and chairs, cots or hammocks, solar panels, hoses, HVAC connections, plumbing connections, electrical connections, and/or other utilities; and/or other components or fixtures may now be used, opened, exposed, extended, connected, and/or accessed. When extendable camper 600 is in an extended position as shown in FIGS. 34-37, slide-out 606, which may be a slide-out compartment in side 604, which may be a front side of main body 602, may be extended from main body 602 to access items inside it or closed to keep items inside a sealed enclosure; and compartment 622, which may be a compartment containing kitchen fixtures in side 620, which may be a front side of extension body 618, may be opened and used as a kitchen or closed to keep food and/or other kitchen items in a sealed enclosure. Whether extendable camper 600 is in a retracted position (e.g., as shown in FIG. 33) or extended position (e.g., as shown in FIGS. 34-37), compartment 610, which may be a collapsible shelter on side 608, which may be a roof of main body 602, may be extended for use as a secondary sleeping or living area on top main body 602; and compartment 624, which may be a storage compartment in side 620, which may be a front side of extension body 618, may be opened to access stored items or closed to keep stored items in a sealed enclosure.

As is the case with extendable camper 600 and as mentioned, main body 602 may be attached to extension body 618; where main body 602 and extension body 618 may have 1 pair of respective, adjacent sides (e.g., located at or near the front of main body 602), when extension body 618 is in a retracted position, as shown in FIG. 33. Additionally, portions of the frame of main body 602, if present, such as the tongue in the front, which may extend beyond the front side of main body 602, may also be adjacent to portions of extension body 618. With extension body 618 extended away from main body 602, as shown in FIGS. 34-37, features in or on the pair of adjacent sides of main body 602 and extension body 618 (e.g., features on the adjacent sides of main body 602 and extension body 618 that abut or face each other in a retracted position, as shown in FIG. 33, where those features may be blocked or inaccessible in that position), as mentioned previously, or portions of the frame of main body 602 that extend beyond the sides of main body 602 and are adjacent to portions of extension body 618 (e.g., when in a retracted position) may now be accessible. With extension body 618 in a retracted position, adjacent to main body 602, extendable camper 600 may have a smaller footprint (e.g., reduced length and/or width), which may be preferrable or necessary for transportation and/or storage. Additionally, the surface of side 620 of extension body 618 that abuts or faces side 604 of main body 602 (e.g., when retracted), may have a greater surface area, be flatter, or have other beneficial features for use when compared with the outward-facing surfaces of the same side, allowing for a larger opening on that surface (e.g., to compartment 622), or a flatter, or more beneficial interior surface for use (e.g., when extended); while the outward-facing surface (e.g., outward-facing surface of side 618 that does not abut or face side 604 of main body 602) may have a surface with certain shapes and/or other features that are beneficial for transportation (e.g., when retracted) such as: an outward-facing surface of front side 620 being angled inward, toward the front, for better aerodynamics and/or containing other features for improved aerodynamics or performance while extendable camper 600 is in transit, both on and off road.

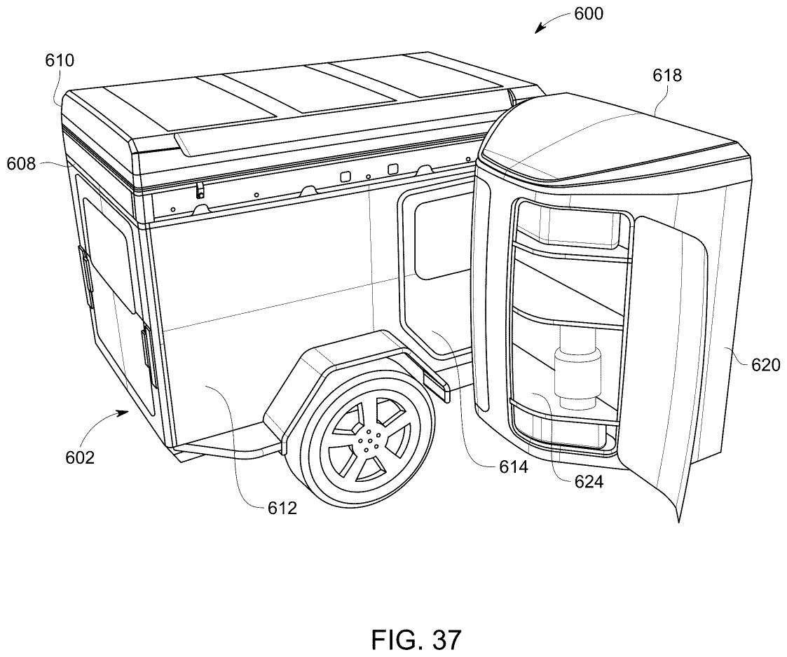

With extension body 618 extended away from main body 602 of extendable camper 600, a side of extension body 618, individually; or together with one or more sides of main body 602, which may be the one or more sides of main body 602 that were adjacent to the side of extension body 618, when in a retracted position, or may be different sides of main body 602, may form one or more additional full or partial enclosures of extendable camper 600. For example, the following pair of sides, which may be adjacent to each other when extension body 618 is in a retracted position, as shown in FIG. 33: side 604 of main body 602 and side 620 of extension body 618; may, when extension body 618 is in an extended position, form a full or partial enclosure to the front side of extendable camper 600, as shown in FIGS. 34-36, comprised of side 604 of main body 602, and side 620 of extension body 618; and a full or partial enclosure to the right side of extendable camper 600, as shown in FIG. 37, comprised of: side 612 of main body 602, and side 620 of extension body 618. With extendable camper 600 having additional full or partial enclosures when extended, as shown in FIGS. 34-37, the following side features may be more fully or partially sheltered and accessed from within the additional enclosures: slide-out 606 in side 604 and opening 614 in side 612 of main body 202, and compartments 622 and 624 in side 620 of extension body 618.

Extendable camper 600 may be extended or retracted manually, by powered means, or by a combination of manual and powered means. Extension body 618 that may be pivotably connected to main body 602 may be extended or retracted by: powered means with actuators or motors; manually-assisted means with gas springs or struts, or with other types of springs or aids; or manual means, with a person pulling, pushing, pivoting, or moving extension body 618. The hinges connecting extension body 618 to main body 602 may contain locks and/or latches and/or other parts of extension body 618, and/or main body 602 may contain locks and/or latches to secure extension body 618 at certain positions (e.g., a retracted position, an extended position, or positions between a fully retracted and fully extended position), until and unless the locks and/or latches are unlocked and/or unlatched, respectively. As shown in FIGS. 33 and 34, portions of two latches 626 may be fixed to main body 602 and the corresponding portions of the two latches 626 may be fixed to extension body 618, keeping extension body 618 latched to main body 602, when extendable camper 600 is in a retracted position, as shown in FIG. 33, or may be unlatched so that extension body 618 may be extended away from main body 602, as shown in FIG. 34.

Extendable campers 1, 100, 200, 300, 400, 500, and 600 demonstrate some embodiments of extendable campers. Main bodies, extension bodies, sides, components, features, and benefits of campers 1, 100, 200, 300, 400, 500, and 600 described above may be the same or similar between each embodiment, different, or combined in other ways to form other embodiments of extendable campers. Extension bodies described above that are configured to extend horizontally to the right side may, alternatively, be configured to extend horizontally to the left side. Extension bodies described above with sides adjacent to the front of the main body, when retracted, may, alternatively, be configured to have sides adjacent to the rear of the main body, when retracted; and extension bodies described above with sides adjacent to the rear of the main body, when retracted, may, alternatively, be configured to have sides adjacent to the front of the main body, when retracted. Similarly, extension bodies described above with sides adjacent to the right side of the main body, when retracted, may, alternatively, be configured to have sides adjacent to the left side of the main body, when retracted; and extension bodies described above with sides adjacent to the left side of the main body, when retracted, may, alternatively, be configured to have sides adjacent to the right side of the main body, when retracted. It may be possible for a main body configuration to serve as a single platform to which various extension bodies may be attached to create the various embodiments of extendable campers listed above or to create other embodiments. Or multiple main body platforms may be used to create various extendable camper embodiments.

1. An extendable camper comprising:
a main body; and
a first external extension body and a second external extension body configured to move between:
a retracted position, in which the main body is collapsed into the first external extension body, and the second external extension body is collapsed into the main body, and
an extended position, in which the external extension bodies extend or pivot outward in opposite directions from the main body,
wherein the main body forms an independent enclosure.

2. The extendable camper according to claim 1, wherein in the extracted position, the external extension bodies and sides of the main body form enclosures, respectively.

3. The extendable camper according to claim 1, wherein at least a part of the second external extension body is made of a soft shell.

4. The extendable camper according to claim 1, wherein a front wall of the first external extension body is angled.

5. The extendable camper according to claim 1, wherein a rear wall of the first external extension body is connected to a floor of the first external extension body via an upwardly sloping wall.

6. The extendable camper according to claim 1, wherein the external extension bodies slide by rails or pivot by hinges between the retracted position and the extended position, respectively.

7. The extendable camper according to claim 1, wherein at least one of the floors of the first and second external extension bodies are pivoted or hinged from side walls of the main body by hinges, respectively.

8. The extendable camper according to claim 1, further comprising a collapsible shelter.

9. The extendable camper according to claim 8, wherein the collapsible shelter is positioned on a top side of the main body.

10. An extendable camper comprising:
a main body; and
an external extension body configured to move between:
a retracted position, in which the external extension body is positioned adjacent to the main body, and
an extended position, in which the external extension body and a side of the main body form a partial enclosure.

11. The extendable camper according to claim 10, wherein the external extension body slides by a rail or pivots by a hinge between the retracted position and the extended position.

12. The extendable camper according to claim 10, wherein a front wall of the external extension body is angled.

13. The extendable camper according to claim 10, further comprising a collapsible shelter.

14. The extendable camper according to claim 13, wherein the collapsible shelter is positioned on a top side of the main body.

15. An extendable camper comprising:
a main body; and
an external extension body configured to move between:
a retracted position, in which the external extension body is positioned adjacent to the main body, and
an extended position, in which the external extension body extends or pivots outward horizontally from the main body such that the main body and the external extension body each form independent enclosures.

16. The extendable camper according to claim 15, wherein in the extended position, the external extension body forms a front end body of the extendable camper.

17. The extendable camper according to claim 15, wherein the external extension body slides by a rail or pivots by a hinge between the retracted position and the extended position by a rail.

18. The extendable camper according to claim 15, wherein the external extension body comprises curtain vestibules and an awning extended out from the main body.

19. The extendable camper according to claim 15, further comprising a collapsible shelter.

20. The extendable camper according to claim 19, wherein the collapsible shelter is positioned on a top side of the main body.
